(19) United States
(12) Patent Application Publication
(10) Pub. No.: US 2020/0272753 A1
(43) Pub. Date: Aug. 27, 2020

(54) PERSONAL DATA HUB METHOD, APPARATUS, AND SYSTEM

(71) Applicants: Paul R. Goldberg, Palo Alto, CA (US); Frances M. Goldberg, Palo Alto, CA (US)

(72) Inventors: Paul R. Goldberg, Palo Alto, CA (US); Frances M. Goldberg, Palo Alto, CA (US)

(21) Appl. No.: 16/871,047

(22) Filed: May 11, 2020

Related U.S. Application Data
(63) Continuation-in-part of application No. 16/236,467, filed on Dec. 29, 2018.

(51) Int. Cl. G06F 21/62; G06Q 30/00

(52) U.S. Cl. CPC G06F 21/6218; G06Q 30/018

(57) ABSTRACT

The present invention provides a method, apparatus, and system to provision to a Recipient a Processed Data Element carrying a Perception related to an individual, the Processed Data Element being generated from data acquired from a networked connected device used by the data subject, where the Processed Data Element is provisioned to the Recipient by the command of the data subject. Prior to the data subject issuing such command, the present invention presents to the data subject information related to the Recipient, or information related to an implication associated with the provisioning of the Processed Data Element to the Recipient. In accordance with many data protection regulations, the command serves as explicit informed consent by the data subject for the Recipient to use the provisioned process Data Element for the benefit of the Recipient. This explicit informed consent, or the provisioning by the present invention of only processed data while disallowing the data subject's unprocessed data from being accessed by, or provisioned to, the Recipient, can significantly ease the burden on the Recipient associated with meeting the data protection requirements mandated by regulations in the governmental jurisdictions in which the Recipient may, or does, operate.

### CROSS REFERENCE TO RELATED APPLICATIONS

This application is a continuation-in-part of co-pending U.S. Non-Provisional application Ser. No. 16/236,467 filed Dec. 29, 2018.

### BACKGROUND OF INVENTION

### 1. Field of Invention

The field of invention is compliance processing. In particular, the present invention relates to the processing of data to provide it with attributes that allow it to comply with regulations enforced in a governmental jurisdiction.

### 2. Discussion of Related Art

Today commercial, financial, government, political, health care, and religious organizations, to name just a few, collect and use massive amount of data to support their activities. Data collected from and on individuals, who either directly or indirectly interact with these organizations, may be used by the collecting organization, and often by organizations affiliated with the collecting organization, to facilitate consumer behavioral targeting or profiling. A growing portion of the data is collected by means of one or more connected devices used by individuals. The data is communicated to one or more organizations who may sell the data to generate a revenue stream, analyze the data and use the analysis results to communicate targeted messages to those individuals, or analyze the data and use the analysis results to profile those individuals in order to include or exclude groups of individuals who display certain characteristics from offers, opportunities, or future interaction. Individuals whose data are collected are most often unaware that their data is being collected, have no way of disallowing their data from being collected if they so choose, do not know all the organizations collecting their data, and have no say as to how their data is being used and shared once it is collected.

Government jurisdictions around the world have become concerned about the widespread use of the portion of this data that is considered personal to the data subjects from which it was collected. In response to this concern they have enacted, and continue to enact, regulations to protect the privacy of these individuals, as well as to give these individuals a say in whether or not they want their data collected, and how and by whom their data is used once it is collected. A first of such privacy regulations is the “EU Regulation 2016/679 of the European Parliament and of the Council of 27 Apr. 2016 On The Protection Of Natural Persons With Regard To The Processing Of Personal Data And On The Free Movement Of Such Data, And Repealing Directive 95/46/EC”. It came into effect in the European Union on May 25, 2018. This regulation is commonly referred to as the “General Data Protection Regulation” or GDPR. A second of such privacy regulations was passed by the California legislature on Jun. 28, 2018. It is the “2018 California Consumer Privacy Act” or CCPA, which went into effect on Jan. 1, 2020. This regulation, like the GDPR, grants a data subject a right to request an organization to disclose the categories and specific pieces of personal information that it collects about the data subject, the categories of sources from which that information is collected, the purposes for collecting or selling the information, and the categories of 3rd parties with which the information is shared. Although the CCPA has much in common with the GDPR, its stated definitions and detailed requirements are significantly different. One very important difference between the GDPR and the CCPA is the definition of “personal information” in the CCPA and the definition of “personal data” in the GDPR. In the CCPA's definition of personal information, information that is publicly available, or that is de-identified, is not included in “personal information”, while in the GDPR's definition of “personal data” it is. These conflicting definitions will place a heavy burden on organizations that seek to be in compliance with both regulations. They will need to spend costly personnel, capital equipment, and legal resources to separate collected data into the categories of ‘personal data’, ‘personal information’, ‘non-personal data’, ‘personal information that is publicly available’, and ‘personal information that has been de-identified’, and thereafter verify that such separation meets the requirements of each regulation. As the number of conflicting government privacy regulations increase, organizations faced with the need to comply with multiple privacy regimes may find the ongoing costs associated with such compliance untenable.

Therefore, there is a need for a technology that provides organizations with a source of data related to individuals who they directly or indirectly interact with, that meets data protection requirements mandated by regulations in the governmental jurisdictions in which they operate.

### SUMMARY OF INVENTION

The present invention provides a method, apparatus, and system to provision to a Recipient a Processed Data Element carrying a Perception related to a data subject, the Processed Data Element being generated from data acquired from a networked connected device used by the data subject, where the Processed Data Element is provisioned to the Recipient by the command of the data subject. Prior to the data subject issuing such command, the present invention presents to the data subject information related to the Recipient, or information related to an implication associated with the provisioning of the Processed Data Element to the Recipient. In accordance with many data protection regulations, the command serves as explicit informed consent by the data subject for the Recipient to use the provisioned Processed Data Element for the benefit of the Recipient. This explicit informed consent, or the provisioning by the present invention of only processed data while disallowing the data subject's unprocessed data from being accessed by, or provisioned to, the Recipient, can significantly ease the burden on the Recipient associated with meeting the data protection requirements mandated by regulations in the governmental jurisdictions in which the Recipient may, or does, operate.

More specifically, the present invention employs the use of an apparatus, supported by a method and system, in which a data subject's acquired data is processed to generate a Processed Data Element, and the data subject provides explicit informed consent for a Recipient to use the Processed Data Element by commanding the communication of the Processed Data Element to the Recipient. In the present invention, the data subject whose processed data is provisioned is the Data Controller of the apparatus. In some embodiments of the present invention, the Processed Data Element is customized to the needs of the Recipient. Such apparatus, to be hereafter referred to as a “Personal Data Hub” (PDH), acquires data from one or more network connected devices used by the data subject by use of a “Network Communication Interface” (NCI), securely stores the acquired data in a “Data Storage Unit” (DSU), generates a Processed Data Element that relates to the data subject from the stored acquired data, or portions of the stored acquired data, and at the direction of the data subject, provisions the generated Processed Data Element to a Recipient. Unprocessed Data Elements stored in the DSU acquired from a device used by the data subject are disallowed from being provisioned to, or accessed by, the Recipient. These actions are effected by the use of one or more Code Modules executing on a “Computer Processor Unit” (CPU), incorporated in the PDH.

Additionally, one or more Code Modules executing on a CPU incorporated in the PDH: may cause the CPU to generate a “User Interface” (UI), that is configured to provide information to the data subject and accept information or commands from the data subject; may cause the CPU to communicate the generated UI to the network connected device used by the data subject in communication with the PDH by use of the NCI; may cause the CPU to receive from the network connected device used by the data subject in communication with the PDH by use of the NCI, a command to provision to the Recipient the Processed Data Element that relates to the data subject, the communicated generated UI having accepted the command from the data subject; may cause the CPU to choose for provisioning to the Recipient the Processed Data Element that relates to the data subject commanded to be provisioned to the Recipient by the data subject; and may cause the CPU to provision to the Recipient, by use of the NCI, the chosen Processed Data Element that relates to the data subject.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram that depicts the data environment in which a Personal Data Hub of the present invention operates.

FIG. 2 is a flowchart illustrating a sequence of actions performed by a Personal Data Hub apparatus of the present invention.

FIG. 3 is a block diagram that depicts the components comprising an embodiment of a Personal Data Hub apparatus of the present invention.

FIG. 4 is a flowchart illustrating the sequence of actions taken by a Computer Processor Unit incorporated in a Personal Data Hub apparatus of the present invention executing a “Data Acquisition Code Module” of the present invention.

FIG. 5 is a flowchart illustrating the sequence of actions taken by a Computer Processor Unit incorporated in a Personal Data Hub apparatus of the present invention executing a Data Selection Code Module of the present invention.

FIG. 6 is a flow chart illustrating the sequence of actions taken by a Computer Processor Unit incorporated in a Personal Data Hub apparatus of the present invention executing a Personal Data Separation Code Module and a Processed Data Element Code Module of the present invention.

FIG. 7 is a block diagram that depicts the interactions between the participants in the environment of FIG. 1 and a Computer Processor Unit incorporated in a Personal Data Hub apparatus of the present invention, while executing a Querying Recipient Interaction Code Module of the present invention.

FIG. 8 is a flowchart illustrating the sequence of actions taken by a Computer Processor Unit incorporated in a Personal Data Hub apparatus of the present invention executing a Time Stamp Generation Code Module and a Support Data Marking Code Module of the present invention.

FIG. 9 is a flowchart illustrating the sequence of actions taken by a Computer Processor Unit incorporated in a Personal Data Hub apparatus of the present invention executing a “Data Event Detection Code Module” of the present invention.

FIG. 10A is an illustration of a UTF-8 character string that comprises an example Indexing Data Element generated by a Support Data Marking Code Module of the present invention.

FIG. 10B is an illustration of a UTF-8 character string contained in an example text data file that is generated by a Support Data Marking Code Module of the present invention.

FIG. 11 is a flowchart illustrating the sequence of actions taken by a Computer Processor Unit incorporated in a Personal Data Hub apparatus of the present invention executing a “Encryption Decryption Code Module” of the present invention.

FIG. 12 is a block diagram depicting the components comprising an embodiment of a system of the present invention.

### DETAILED DESCRIPTION OF INVENTION

The present invention will now be described more fully hereinafter with reference to the accompanying drawings, which form a part thereof, and which show, by way of illustration, an an embodiment by which the invention may be practiced. The invention may, however, be implemented in the form of many different embodiments and should not be construed as limited to the embodiment set forth herein; rather, this embodiment is provided so that this disclosure will be thorough and complete, and will fully convey the scope of the invention to those skilled in the art. Among other things, the present invention may be embodied as methods or devices. Accordingly, an embodiment of the present invention may take the form of an entirely hardware embodiment, and entirely software embodiment or an embodiment combining software and hardware aspects. The following detailed description is, therefore, not to be taken in a limiting sense.

Throughout the specification, figures, abstract, and claims the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or”, unless the context clearly dictates otherwise. The term “based on” is not exclusive and allows for being based on additional factors not described, unless the context clearly dictates otherwise. In addition, throughout the specification, the meaning of “a”, “an”, “and” and “the” include plural references. The meaning of “in” includes “in” and “on”. Also, the use of “including”, “includes”, “comprising” “comprised of”, “having”, “containing”, “contained in”, “involving”, and variations thereof herein, is meant to encompass the items listed thereafter and equivalents thereof as well as additional items.

Also, throughout the specification, figures, abstract, and claims the following acronyms have the following meanings: ACPU is an acronym for “Apparatus Computer Processor Unit”; ADSU is an acronym for “Apparatus Data Storage Unit”; AI is an acronym for “Artificial Intelligence”; ANCI is an acronym for “Apparatus Network Communication Interface”; API is an acronym for “Application Program Interface”; APP is an acronym for “Application Program”; CCPA is an acronym for the “California Consumer Privacy Act”; CES is an acronym for “Character Encoding Scheme”; CPU is an acronym for “Computer Processor Unit”; DACM is an acronym for “Data Acquisition Code module”; DAPP is an acronym for “Device Application Program”; DCPU is an acronym for “Device Computer Processor Unit”; DDSU is an acronym for “Device Data Storage Unit”; DEDCM is an acronym for “Data Event Detection Code Module”; DL is an acronym for “Deep Learning”, DID is an acronym for “Device Information Display”; DM is an acronym for “Data Mining”; DNCI is an acronym for “Device Network Communication Interface”; DSCM is an acronym for “Data Selection Code Module”; DSP is an acronym for “Data Selection Parameter”; DSU is an acronym for “Data Storage Unit”; EDCM is an acronym for “Encryption Decryption Code Module”; GDPR is an acronym for “General Data Protection Regulation”; GnuPG is an acronym for “Gnu Privacy Guard”; GPS is an acronym for “Global Positioning System”; IOT is an acronym for “Internet Of Things”; ML is an acronym for “Machine Learning”; NCI is an acronym for “Network Communcation Interface”; NN is an acronym for “Neural Network”; NPD is an acronym for “Non-Personal Data”; OS is an acronym for “Operating System”; PD is an acronym for “Personal Data”; PDC is an acronym for “Personal Data Container”; PDCCM is an acronym for “Personal Data Container Code Module”; PDECM is an acronym for “Processed Data Element Code Module”; PDH is an acronym for “Personal Data Hub”; PDSCM is an acronym for “Personal Data Separation Code Module”; PGP is an acronym for “Pretty Good Privacy”; QR is an acronym for “Querying Recipient”; QRICM is an acronym for “Querying Recipient Interaction Code Module”; RTC is an acronym for “Real-Time Clock”; SDMCM is an acronym for “Support Data Marking Code Module”; TSGCM is an acronym for “Time Stamp Generation Code Module”; two-way DID is an acronym for “two-way Device Information Display”; UI is an acronym for “User Interface”; URL an acronym for “Uniform Resource Locator”; UTC is an acronym for “Coordinated Universal Time”; and UUID is an acronym for “Universally Unique Identifier”.

Furthermore, throughout the specification, figures, abstract, and claims the term “Recipient” refers to commercial, financial, government, political, health care, or religious organizations, to name just a few, that collect and use data to support their activities.

Additionally, throughout the specification, figures, abstract, and claims the term “Computer Processor Unit” (CPU), or variations thereof such as “Apparatus Computer Processor Unit” (ACPU), or “Device Computer Processor Unit” (DCPU), is meant to include a single Computer Processor Unit, or multiple Computer Processor Units. When the term encompasses multiple Computer Processor Units, each of such CPUs may operate on a Data Element unilaterally, in parallel with another CPU on the same or a different Data Element, or in serial with another CPU. In this latter case, processed data resulting from actions of a first CPU on a Data Element are further processed by a second CPU.

In addition, throughout the specification, figures, abstract, and claims a “Code Module” is defined as a computer program comprised of one or more computer algorithms that when executed on a CPU perform one or more specific actions or tests. Also, the phrase “a Code Module” as used herein does not necessarily refer to the same Code Module, though it may.

Further, throughout the specification, figures, abstract, and claims a “Data Element” is defined as a grouping of one or more digital bytes that convey cohesive intelligence. The digital bytes that comprise a Data Element may represent a single item of intelligence or multiple items of related intelligence. The intelligence carried by the digital bytes of a Data Element may represent, for example, a physical data value such as a temperature, sound intensity, motion direction, rate, velocity, acceleration, electrical impedance, or capacitance; a set of position coordinates provided by a GPS; a date or time from a RTC; an network address; a web page address in the form of a URL; a text message, an email, or a notification communicated to, or received from, a network source; a descriptive phrase in the context of a spoken or written language associated with an object, a person, a place, an activity, an attribute, or thing; a reference to, an excerpt from, or a complete written work such as a document, a legal text, a technical publication, a medical record, a financial record, or an authoritative treatise; or a reference to, or a digital representation of, a graphic work such as a drawing, photograph, painting, artistic rendering, or video; or a reference to, or a digital representation of, an audio work such as a musical composition, or sounds present in an audio landscape. Such intelligence may be in human readable form or encoded such that the intelligence may be interpreted by the actions of a CPU operating on the Data Element. In the discussion that follows, the term “Data Element” will generally refer to a unit of data input or output from a network connected device used by a data subject.

In addition, throughout the specification, figures, abstract, and claims a “Processed Data Element” is defined as a Data Element generated from one or more Data Elements acquired from one or more network connected sources, where such one or more Data Elements have been acted on by one or more Code Modules executed on a CPU, each such Code Module employing one or more algorithms, to produce a Data Element that carries a Perception about a person, place, or thing. An example Processed Data Element is an inference or profile of characteristics related to a data subject.

Additionally, throughout the specification, figures, abstract, and claims a “Data Controller” is defined as a natural person, an individual, that determines or authorizes: the purpose for processing data acquired from a device; the scope of the processing of data acquired from a device; the methodology used to process data acquired from a device; and the Recipient to which the result of processing data acquired from a device is provisioned.

Also, throughout the specification, figures, abstract, and claims “Support Data” is defined as data that describes or gives information about other data.

Furthermore, throughout the specification, figures, abstract, and claims “Data Marking” is defined as the tagging of data with ancillary or supporting data related to the primary payload data; and, depending on context, the term “information” may be substituted for the term “data”.

In addition, throughout the specification, figures, abstract, and claims the word “Perception” takes on the definition stated in Paragraph 2.d. of the on line version of the “American Heritage Dictionary of the English Language”, Universal Resource Locater (URL) https://www.andictionary.com/word/search.html?q=perception which is “An insight or point of knowledge”.

An apparatus of the present invention acquires and stores data output from a network connected device used by a data subject in a secure network connected data storage and processing apparatus. The data subject is the Data Controller of the apparatus. Although the terms “a network connected device” and “the network connected device” are used throughout this discussion in reference to the storage and processing of data acquired from a device used by the data subject, an apparatus of the present invention may interact with two or more network connected devices used by the data subject simultaneously or in sequence. In this discussion, the apparatus is referred to as a “Personal Data Hub” (PDH). A “Computer Processor Unit” (CPU), a “Data Storage Unit” (DSU), and a “Network Communications Interface” (NCI) are incorporated in the PDH. One or more Code Modules executing on the CPU of the PDH causes the CPU to: acquire data from one or more network connected devices used by the data subject by use of the NCI; securely store the acquired data in the DSU; disallow unprocessed Data Elements stored in the DSU from being provisioned to, or accessed by, the Recipient; generate a Processed Data Element carrying a Perception that relates to the data subject from the stored acquired data, or portions of the stored acquired data; and, under the control of the data subject, provision the generated Processed Data Element to a Recipient.

In the case of two or more devices used by the data subject being in communication with the PDH by use of the NCI of the PDH, a Code Module executing on the CPU of the PDH causes the data acquired from each of the devices to be combined and stored in the DSU of the PDH. This permits the combined data to be processed as if the data were acquired from a single device. There are many data combining approaches that can used to achieve this result. For example, one such data combining approach is to append data acquired from a second device used by the data subject, to the data acquired from a first device used by the data subject and store the result in a single file in the DSU of the PDH. A second approach is to store data acquired from a second device used by the data subject and data acquired from a first device used by the data subject in the DSU of the PDH in two separate files that are linked. In this second approach, the processing of the first file of acquired data would continue past the end of the first file to the processing of the second file to which it is linked. There are many ways to link files to facilitate serial processing of the files. In this discussion, the Code Module executing on the CPU of the PDH that causes the CPU to: acquire data from one or more network connected devices used by the data subject; combine data acquired from 2 or more network connected devices used by the data subject; securely store the acquired data in the DSU of the PDH; and disallow unprocessed data from being provisioned to, or accessed by, the Recipient, is referred to as a “Data Acquisition Code module”, or DACM.

Prior to Processed Data Element generation, a portion of the stored data may be selected for Processed Data Element generation by use of a parameter controlled data selection Code Module. In this discussion, this Code Module is referred to as a “Data Selection Code Module”, or DSCM. Example parameters that may be used to control the selectivity of the DSCM include: a time parameter to cause the DSCM to select the portion of the stored data output from the device at a particular time or times; a physical location parameter to cause the DSCM to select the portion of the stored data output from the device that was output from the device when the device was at a particular physical location or physical locations; a URL or network address parameter to cause the DSCM to select the portion of the stored data output from the device when the device accessed a particular URL or network address or particular URLs or network addresses; or an environmental condition parameter to cause the DSCM to select the portion of the stored data output from the device when particular weather conditions were in affect at a location at which the device was situated. A DSCM, or a parameter used by the DSCM, to be referred to in this discussion as a “Data Selection Parameter” or a DSP, may be incorporated in the PDH at the time of PDH manufacture, downloaded to the PDH from the PDH manufacturer or an agent of the PDH manufacturer subsequent to the time of manufacture, downloaded to the PDH from a Recipient or an agent of a Recipient desirous of obtaining access to a Processed Data Element carrying a Perception related to the data subject, such a Recipient to be referred to in this discussion as a “Querying Recipient” or QR, downloaded to the PDH from a government agency, downloaded to the PDH from a source approved by a government agency, downloaded to the PDH from an independent Code Module developer, or provided by the data subject who uses the network connected device from which the portion of data to be selected is acquired. The data subject may effect the download of a DSCM, may approve the execution of a DSCM on the CPU of the PDH, may approve the use of a parameter by the DSCM, or may provide a parameter used by the DSCM. Such actions may be effected by use of a “User Interface” or UI that is communicated to the network connected device used by the data subject from the PDH. The UI would be displayed on a “Device Information Display” (DID), incorporated in the device used by the data subject. The DID may be capable of displaying information visually, acoustically, or tactually to the data subject, or accepting information from the data subject visually, acoustically, or tactually. In this discussion such a DID is referred to as a “two-way Device Information Display” or “two-way DID”. In the context of the present invention, the two-way DID may include, but not be limited to, an LCD, OLED, MicroLED, quantum dot, or other type of display screen, in cooperation with a separate camera, to display and accept information from the data subject “visually”; the two-way DID may include, but not be limited to, a speaker or microphone to display and accept information from the data subject acoustically; or the two-way DID may include, but not be limited to, a touchscreen display employing vibrational, or non-contact haptic technology, or capacitive, resistive, acoustic wave, optical imaging touch sensitive technologies, or a separate hardware keyboard, keypad, touchpad or other pointing device, to display and accept information from the data subject tactually. If the PDH does not include a DSCM to select data from the stored data that conforms to a parameter, or the DSCM in the PDH is disabled, all the stored data may be used by the CPU incorporated in the PDH to generate a Processed Data Element carrying a Perception related to the data subject.

In the present invention the stored data, or a portion of the stored data, output from the device used by the data subject, that is processed to generate a Processed Data Element carrying a Perception related to the data subject, may be separated into a “Personal Data” (PD}, part and a “Non-Personal Data” NPD, data part prior to Data Element processing. Such separation may be effected by use of a “Personal Data Separation Code Module”, or PDSCM, executing on the CPU incorporated in the PDH. A PDSCM may be incorporated in the PDH at the time of PDH manufacture, downloaded to the PDH from the PDH manufacturer or an agent of the PDH manufacturer subsequent to the time of manufacture, downloaded to the PDH from the QR or an agent of the QR, downloaded to the PDH from a government agency, downloaded to the PDH from a source approved by a government agency, or downloaded to the PDH from an independent Code Module developer. Effecting the download of a PDSCM, or executing a PDSCM, may be authorized by the data subject by use of a UI that is communicated to the network connected device used by the data subject from the PDH and displayed on a two-way DID incorporated in the device. In addition, the data subject may direct that a Data Element is to be treated as being “personal” by the PDSCM executing on the CPU of the PDH, by use of the two-way DID. In general, the DID may provide information to the data subject and accept information or commands from the data subject related to the functionality of the PDSCM, visually, acoustically, or tactually. Processing of the PD or NPD parts of the stored data, or a portion of the stored data, output from the network connected device used by the data subject, may be directed to the generation of a Processed Data Element that relates to many different aspects of the data subject's past, present or future behavior, financial conditions, educational level, medical condition, physical characteristics, military service, employment circumstances, living circumstances, religious affiliations, political affiliations, beliefs, family situation, or interpersonal interactions, for instance. An inference related to the data subject, or a profile of characteristics related to the data subject, are examples of a Processed Data Element carrying a Perception related to the data subject.

Processing of the stored data, or a portion of the stored data, to generate a Processed Data Element carrying a Perception related to the data subject, may be effected by a Code Module executing on the CPU incorporated in the PDH. Under the direction of this Code Module, the CPU may use stored data acquired from the network connected device used by the data subject, in combination with supplementary data related to the data subject stored in the DSU of the PDH, to generate the Processed Data Element carrying a Perception related to the data subject. The acquisition from a network source, and storage of such supplementary data in the DSU of the PDH, may be effected by the CPU using the NCI of the PDH, under the direction of the Code Module responsible for generating the Processed Data Element carrying a Perception related to the data subject. Generating a Processed Data Element carrying a Perception related to the data subject from data stored in the data storage unit acquired from one or more network connected devices used by the data subject, may be effected by a “Processed Data Element Code Module”, or PDECM, executing on the CPU incorporated in the PDH. The PDECM may, for example, employ an “Artificial Intelligence” (AI), “Machine Learning” (ML), “Neural Network” (NN), “Data Mining” (DM), Deep Learning (DL) or other algorithm, to generate from the PD or NPD parts a Processed Data Element carrying a Perception related to the data subject. The Processed Data Element may carry a Perception which is an inference related to the data subject that may, for example, be a health concern the data subject may have, a financial concern the data subject may have, a religious belief the data subject may hold, a political belief the data subject may hold, a propensity of the data subject to participate in a particular activity, a current and future desire or need the data subject may have, or a predicted future behavior of the data subject. The Processed Data Element may carry a Perception which is a profile of characteristics attributable to the data subject that may, for example, be comprised of the data subject's possible age, gender, race, religion, family ancestry, financial status, health status, political affiliations, or club affiliations. The PDECM may be a Code Module incorporated in the PDH at the time of PDH manufacture, downloaded to the PDH from the PDH manufacturer or an agent of the PDH manufacturer subsequent to the time of manufacture, downloaded to the PDH from the QR or an agent of the QR, downloaded to the PDH from a government agency, downloaded to the PDH from a source approved by a government agency, or downloaded to the PDH from an independent Code Module developer. Effecting the download of a PDECM, or executing a PDECM, may be authorized by the data subject by use of a UI that is communicated to the network connected device used by the data subject from the PDH and displayed on a two-way DID incorporated in the device. If the PDH does not include a PDSCM executing on the CPU incorporated in the PDH to separate the stored data into PD and NPD parts, or the PDSCM is disabled, the PDECM executing on the CPU incorporated in the PDH may employ unseparated stored data, comprised of both PD and NPD data, to generate a Processed Data Element carrying a Perception related to the data subject.

A Code Module executing on the CPU incorporated in the PDH, to be referred to in this discussion as a “Querying Recipient Interaction Code Module” or QRICM, executing on the CPU incorporated in the PDH, may receive a request from a QR for a generated Processed Data Element carrying a Perception related to the data subject who is the Data Controller of the PDH. The CPU may receive the request from the QR by use of the NCI incorporated in the PDH. The request from the QR would include a network address where the QR wants the PDH to provision the generated Processed Data Element. Along with the request, the QR may provide information to the QRICM related to the QR. To obtain additional information related to the QR, the QRICM may access a supplementary network based data source by use of the NCI. QR provided data, or data from a supplementary network based data source, related to the QR, may be stored in the DSU incorporated in the PDH. The QR may also provide a DSP, a DSCM, a PDSCM, or a PDECM that the QR wants the PDH to use to process the data used to generate the Processed Data Element. In this case, the QRICM executing on the CPU would download the DSP, or the Code Modules, using the NCI, and store them in the DSU. The use of a DSP, DSCM, PDSCM or PDECM provided by the QR for the processing of data acquired from a network connected device used by the data subject who is the Data Controller of the apparatus, in order to generate the Processed Data Element carrying a Perception related to the data subject, provides the QR with an opportunity to obtain a provisioned Processed Data Element customized to its needs.

The QRICM may additionally cause the CPU incorporated in the PDH to communicate information that relates to the QR to the network connected device used by the data subject by use of the NCI incorporated in the PDH. The information related to the QR may be processed prior to such communication by the QRICM to provide the data subject with a summary of the information related to the QR. This summary may be in a textual, verbal or graphical format to facilitate the ready understanding of the information by the data subject. The QRICM may cause the CPU to generate a UI, populate the UI with information related to the requesting QR, and communicate the populated UI to the network connected device used by the data subject in communication with the PDH, by use of the NCI. A “Device Application Program”, to be referred to in this discussion as a DAPP, executing on a CPU incorporated in the device used by the data subject, to be referred to in this discussion as a “Device Computer Processor Unit”, or DCPU, receives the populated UI, by use of a “Device Network Communication Interface”, to be referred to in this discussion as a DNCI. The DAPP presents the UI to the data subject by use of a two-way DID incorporated in the device used by individual. Recall that a two-way DID may be capable of displaying information visually, acoustically, or tactually to the data subject, or accepting information from the data subject visually, acoustically, or tactually. The information related to the QR may include: the QR's identity; the identity of one or more third parties with whom the QR may share the generated Processed Data Element; the categories of third parties with whom the QR may share the generated Processed Data Element; the purpose, or purposes, to which the QR may apply the generated Processed Data Element; the identity of the QR, manufacturer, or independent Code Module developer that provided the PDECM to the PDH used to generate the Processed Data Element; or the conditions defined by the QR that would cause the PDH to provision the generated Processed Data Element to the QR. Such conditions may include the following events related to the data subject: when the device used by the data subject visits a particular URL or network address defined by the QR; when the device used by the data subject becomes physically located at a particular physical location defined by the QR, as may be indicated by a GPS incorporated in the device, or some other geolocation positioning system; when a particular time of day, day of week, month of year, or calendar year defined by the QR occurs; when a particular length of time defined by the QR has passed since the previous provisioning to the QR of a Processed Data Element; or when a Processed Data Element related to the data subject has changed from a previous Processed Data Element related to the data subject in a way defined by the QR. Such a change may, for example, be in predicted future behavior, current financial status, or current health status.

In addition to information related to the QR, the QRICM may cause the CPU to communicate to the network connected device used by the data subject, by use of the NCI incorporated in the PDH, information related to a Processed Data Element carrying a Perception related to the data subject proposed to be provisioned to the QR. The information may include the Perception in whole, in part, or in summary, as well as additional information related to the Perception. The information may be formatted by the QRICM into a textual, verbal or graphical presentation to facilitate a ready understanding by the data subject of the Perception. In addition, the QRICM may process the Perception by itself, or in combination with information related to the QR, in order to generate a presentation of one or more possible implications to the data subject, should the Processed Data Element carrying the Perception be provisioned to the QR. The QRICM may, for example, use an Artificial Intelligence (AI), Machine Learning (ML), Neural Network (NN), Data Mining (DM), Deep Learning (DL) or other algorithm, to generate the presentation. The QRICM may cause the CPU to communicate to the network connected device used by the data subject a populated UI containing the information pertaining to the Perception, or the presentation of one or more possible implications to the data subject, prior to the data subject deciding whether or not to provision the Processed Data Element to the QR. A DAPP executing on a DCPU incorporated in the device used by the data subject may present the UI to the data subject by use of a two-way DID incorporated in the device used by individual.

After review by the data subject, the information relating to the QR, or the information relating to the Perception, may be used by the data subject to decide whether or not the Processed Data Element should be provisioned to the QR. If the data subject so chooses, the data subject may use the DID to cause the DAPP executing on the DCPU to communicate a command to the CPU incorporated in the PDH, by use of the DNCI incorporated in the device used by the data subject. The command may be to provision the Processed Data Element carrying the Perception to the QR immediately, to provision the Processed Data Element carrying the Perception to the QR following the detection of an occurrence of an event related to the data subject, or to not provision the Processed Data Element carrying the Perception to the QR. The QRICM may receive the command from the network connected device used by the data subject by use of the NCI incorporated in the PDH, and carry out the directive of the data subject. In either the immediate or delayed provisioning case, the generated Processed Data Element is first packaged for provisioning to the QR, such packaging facilitating the use and tracking of the generated Processed Data Element after provisioning. The QRICM then causes the CPU incorporated in the PDH to provision the generated Processed Data Element carrying the Perception related to the data subject to the network address provided by the QR, by use of the NCI incorporated in the PDH.

Packaging of the Processed Data Element

The packaging of the generated Processed Data Element for provisioning to the QR, may include: the marking of the generated Processed Data Element with Support Data; the generation of a text data file that contains the generated Processed Data Element marked with Support Data; or the encryption of the text data file to the QR's public encryption key. Note that in the context of this discussion “Data Marking” is defined as the tagging of data with ancillary or supporting information related to the primary payload data. With respect to the present invention, the definition of “Primary Payload” is the generated Processed Data Element carrying a Perception related to the data subject provisioned to the QR.

Given the above definition of “Data Marking” and “Primary Payload”, the Processed Data Element carrying a Perception related to the data subject may be marked with Support Data that carries, some, or all, of the following information, as well as additional information: a time stamp indicating the time the Processed Data Element was generated, the identity of the QR indicating that the marked Processed Data Element has been explicitly approved by the data subject for beneficial use by the QR to whom the Processed Data Element is provisioned; the identity of one or more third parties with whom the QR may share the generated Processed Data Element; the category or categories of third parties with whom the QR may share the Processed Data Element; the purpose, or purposes, to which the QR may apply the generated Processed Data Element; the source, or sources, of one or more of the Code Modules used to generate the Processed Data Element carrying the Perception; the event that initiated the provisioning of the generated Processed Data Element to the QR, or the identifier of the PDH that provisioned the generated Processed Data Element to the QR. After the provisioning of the Processed Data Element to the QR, Support Data accompanying the Processed Data Element may be employed by the QR as written evidence that the data subject, who is the PDH Data Controller, provided explicit consent to the QR to use the provisioned Processed Data Element for the benefit of the QR. In addition, Support Data accompanying the Processed Data Element may be employed by the data subject after the provisioning of the Processed Data Element to the Recipient to monitor the QR's post provisioning use, or sharing, of the Processed Data Element.

The marking of the generated Processed Data Element carrying a Perception related to the data subject chosen for provisioning to the QR with Support Data, may be effected by use of a “Support Data Marking Code Module”, or SDMCM, executing on the CPU of the PDH. A “Time Stamp Generation Code Module” (TSGCM), may be executed on the CPU to provide a time stamp to the SDMCM. For this discussion, the time stamp may indicate the time the generation of the Processed Data Element carrying a Perception related to the data subject was completed by the PDECM executing on the CPU incorporated in the PDH. However, the time stamp may indicate other times as well. For example, the time stamp may indicate the time at which the data subject commanded the generated Processed Data Element to be provisioned to the QR. A “Real-Time Clock” (RTC) incorporated in the PDH, synchronized to “Coordinated Universal Time” (UTC), may be used to provide the time to the TSGCM, as well as other Code Modules, executing on the CPU. The TSGCM may be incorporated in the PDH by the manufacturer of the PDH at the time of PDH manufacture, downloaded to the PDH from the PDH manufacturer or an agent of the PDH manufacturer subsequent to the time of manufacture, or downloaded to the PDH from an independent Code Module developer. Effecting the download of a TSGCM, or executing a TSGCM, may be authorized by the data subject by use of a UI that is communicated to the network connected device used by the data subject from the PDH and displayed on a two-way DID incorporated in the device.

As previously mentioned, the marking of the generated Processed Data Element chosen for provisioning to the QR with Support Data may be effected by use of a SDMCM executing on the CPU of the PDH. The SDMCM executing on the PDH may mark the data comprising the generated Processed Data Element with Support Data by use of a digital data marking technique. The SDMCM may be a Code Module incorporated in the PDH at the time of PDH manufacture, downloaded to the PDH from the PDH manufacturer or an agent of the PDH manufacturer subsequent to the time of manufacture, downloaded to the PDH from a QR or an agent of the QR, downloaded to the PDH from a government agency, downloaded to the PDH from a source approved by a government agency, or downloaded to the PDH from an independent Code Module developer. Effecting the download of a SDMCM, or executing a SDMCM, may be authorized by the data subject by use of a UI that is communicated to the network connected device used by the data subject from the PDH and displayed on a two-way DID incorporated in the device.

The SDMCM may also mark the chosen generated Processed Data Element carrying a Perception related to the data subject with a “PDH Identifier”. The PDH Identifier may be used by the QR to determine when the device used by the data subject is in communication with an network address owned, controlled, used, or accessed by the QR. This may allow the QR to take immediate or subsequent actions that may, for example, be aimed at increasing engagement with the data subject visiting the network address, based on a Perception related to the data subject carried by the provisioned Processed Data Element. Such a determination may be facilitated by a DAPP executing on a DCPU incorporated in the device used by the data subject that may be communicated to the device from the PDH. The DAPP may cause the DCPU, by use of a DNCI incorporated in the device, to include the PDH Identifier in the data stream communicated to an network address visited by the device. By monitoring their network presences, extracting the PDH Identifier marked by the SDMCM in the generated Processed Data Element communicated to the QR, and comparing the extracted marked PDH Identifier with the PDH Identifier communicated to the network address visited by the device used by the data subject, the QR may use the communicated PDH Identifier as notification that the data subject is currently in communication with a particular QR network presence.

It should be noted that although a PDH Identifier may be communicated to an network address owned, controlled, used, or accessed by the QR, by the device used by the data subject, the identity of the data subject using the device does not have to be known by the QR. In addition, by use of a UI generated by the DAPP executing on the DCPU, that is displayed on a two-way DID incorporated in the device, the data subject using the device may command the PDH to change the PDH Identifier, such that a subsequent Processed Data Element communicated to the QR is marked with a PDH Identifier that is unrelated to the previous PDH Identifier. This has the affect of obsoleting the previous PDH identifier and thereby effectively causing a Processed Data Element provisioned to the QR marked with the previous Identifier to be no longer actionable.

To facilitate the use by the QR of the generated Processed Data Element carrying a Perception related to the data subject after it is provisioned to the QR, the generated Processed Data Element provisioned to the QR may take the form of a simple Unicode character text string marked by Support Data inserted into the text string. In this approach, a Support Data element may be separated from the generated Processed Data Element payload by a delimiting character, the delimiting character serving as a label that defines the information carried by the string of characters representing the Support Data that follows. A second delimiting character may be used to separate the first Support Data element character string from a second Support Data element character string, the second delimiting character likewise serving as a label that defines the information carried by the string of characters that follows. The large number of characters defined, for example, by the UTF-8 standard, allows for many different characters that may serve as both Support Data labels or separators between Support Data elements, to be inserted in the character text string provisioned to the QR, while maintaining compatibility with a large number of Unicode enabled computer programs capable of reading the character text string. With so many different Support Data labels available, the generated Processed Data Element provisioned to the QR may be accompanied by many different categories of Support Data elements. By incorporating a Unicode based character look-up table in the generated Processed Data Element file provisioned to the QR, the QR may readily decode the information carried by a character that may serve as both a label and a delimiting character.

Although in the current discussion a Unicode character text file is used as the data container carrying a marked Processed Data Element carrying a Perception related to the data subject provisioned to the QR, other data structures may be employed. Such a data structure may be generated by a Code Module executing on the CPU of the PDH, and is referred to in this discussion as a “Personal Data Container” (PDC). A Code Module executing on the CPU of the PDH that generates an instance of the PDC, or performs the process of loading an unpopulated PDC with data, is referred to in this discussion as a “Personal Data Container Code Module” or PDCCM. The PDCCM may be a Code Module incorporated in the PDH at the time of PDH manufacture, downloaded to the PDH from the PDH manufacturer or an agent of the PDH manufacturer subsequent to the time of manufacture, downloaded to the PDH from the QR or an agent of the QR, downloaded to the PDH from a government agency, downloaded to the PDH from a source approved by a government agency, or downloaded to the PDH from an independent Code Module developer. Effecting the download of a PDCCM, or executing a PDCCM, may be authorized by the data subject by use of a UI that is communicated to the network connected device used by the data subject from the PDH and displayed on a two-way DID incorporated in the device.

PDC's may be configured in both standard and proprietary formats. When a PDCCM generates a PDC in a proprietary format, the PDCCM may also generate a reader that can be used to access the marked Processed Data Element loaded into the proprietary PDC. In this case a PDC reader executable may need to be provisioned to the QR along with the generated Processed Data Element carrying a Perception related to the data subject. Alternatively, a standardized file format may be employed to serve as a PDC. For example a MySQL SQL database file, a Microsoft Excel spreadsheet file, or a LibreOffice Calc spreadsheet file, may be used as a PDC. In these cases a spreadsheet “row”, or SQL database record, may be loaded with a Processed Data Element, along with the marked Support Data related to the generated Processed Data Element. Since computer programs are readily available that are capable of reading these files, the PDCCM would not need to generate a reader and provision it to the QR to provide the QR with ready access to the marked Processed Data Element loaded into a provisioned standardized PDC.

The packaging of the chosen Processed Data Element for provisioning to the QR, may include encrypting the Unicode character data file or PDC loaded with the marked Processed Data Element carrying a Perception related to the data subject, by the use of public/private key encryption. Alternatively, other forms of cryptography may be used. Encryption of the generated Processed Data Element may be performed by a Code Module executing on the CPU of the PDH. The encryption may be performed by an “Encryption Decryption Code Module”, or EDCM, that is incorporated in the PDH by the manufacturer of the PDH at the time of PDH manufacture, downloaded to the PDH from the PDH manufacturer or an agent of the PDH manufacturer subsequent to the time of manufacture, downloaded to the PDH from a QR or an agent of the QR, downloaded to the PDH from a government agency, downloaded to the PDH from a source approved by a government agency, or downloaded to the PDH from an independent Code Module developer. If public/private key encryption is used, the generated Processed Data Element may be encrypted to the QR's public key, provided to the PDH by the QR, or downloaded from a trusted key server by the PDH, or signed by the PDH's private key, prior to being communicated to the QR. the generated Processed Data Element may be encrypted or signed so that it can be communicated to the QR as securely as possible. In order to decrypt the signature incorporated in the encrypted Processed Data Element provisioned to the QR, and thus verify that the generated Processed Data Element was provisioned to the QR from the PDH whose Data Controller is the data subject, the PDH may also communicate the PDH's public key to the QR. Alternatively, the QR may download the PDH's public key from a trusted key server.

Event Detection

As previously mentioned, the data subject may command the PDH to provision the generated Processed Data Element carrying a Perception related to the data subject to the QR immediately, to provision the generated Processed Data Element to the QR following the detection of an occurrence of an event related to the data subject, or to not provision the generated Processed Data Element to the QR. In the case of provisioning the generated Processed Data Element when an event occurs, it is necessary for the PDH to effect such provisioning soon after a defined event is detected. An event may be defined by: the data subject visually, acoustically, or tactually through the use of a UI communicated to the device from the PDH displayed on a two-way DID incorporated in the device; may be defined by the QR by means of a message communicated from the QR to the PDH by use of the NCI incorporated in the PDH; or may be defined at the time of PDH manufacture by the manufacturer of the PDH. Once the event is defined, a Code Module executing on the CPU incorporated in the PDH may be used to detect when the event occurs. The event definition may be input to the Code Module executing on the CPU as a parameter. In this discussion such a Code Module is referred to as a “Data Event Detection Code Module” or DEDCM. The DEDCM may monitor data output from the device used by the data subject communicated to the PDH through the NCI incorporated in the PDH to detect the occurrence of the event. The DEDCM may also monitor data communicated to the PDH through the NCI incorporated in the PDH from other network sources to detect the occurrence of the event. Such network sources may, for example, include, but not be limited to, news, weather, governmental, financial, political, social media, or world clock sources. In addition, the DEDCM may also monitor data output from a hardware module built into the PDH, for example a Real-Time Clock (RTC), incorporated in the PDH at the time of PDH manufacture, to detect the occurrence of the event.

There is a broad range of events related to the data subject that may be used to cause a Processed Data Element carrying a Perception related to the data subject, that has been chosen for provisioning to a QR, to be provisioned to the QR. These include: when the device used by the data subject visits a particular URL or network address; when the device used by the data subject becomes physically located at a particular physical location, as may be indicated by a GPS incorporated in the device, or some other geolocation positioning system; when a particular time of day, day of week, month of year, or calendar year occurs; when a particular length of time has passed since the previous communication of a Processed Data Element carrying a Perception related to the data subject has passed; when a Processed Data Element carrying a Perception related to the data subject has changed from a previous Processed Data Element carrying a Perception related to the data subject in a defined way, where such a change may, for example, be in predicted future behavior, current financial status, or current health status; when there is a major weather event such as a flood, hurricane, earth quake or tornado in the area in which the data subject lives; when there is a major financial change such as a rapidly rising or falling stock market, a significant change in house prices, a large rise or fall in consumer spending, a large rise or fall in employment, or a large rise or fall in the cost of living; or when a major change in governmental policy goes into effect. There are many more events that can be added to this list.

A DEDCM may be incorporated in the PDH at the time of PDH manufacture, downloaded to the PDH from the PDH manufacturer or an agent of the PDH manufacturer subsequent to the time of manufacture, downloaded to the PDH from a QR or an agent of the QR, downloaded to the PDH from a government agency, downloaded to the PDH from a source approved by a government agency, or downloaded to the PDH from an independent Code Module developer. Effecting the download of a DEDCM, or executing a DEDCM, may be authorized by the data subject by use of a UI that is communicated to the network connected device used by the data subject from the PDH and displayed on a two-way DID incorporated in the device.

### PREFERRED EMBODIMENT OF INVENTION

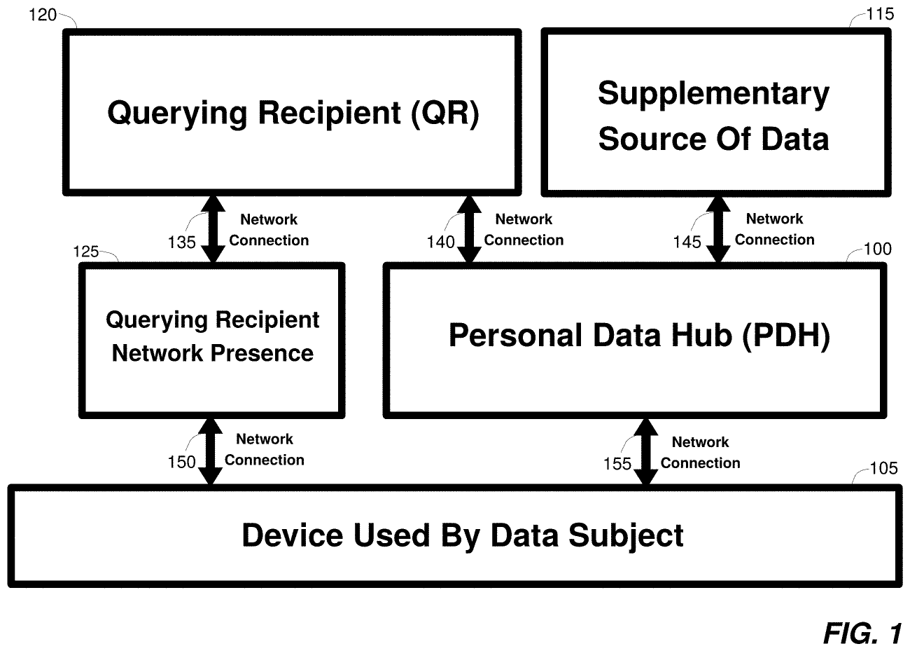

FIG. 1 is a block diagram that depicts the environment in which an apparatus of the present invention operates. As can be seen from FIG. 1, the environment is populated by 5 major participants. These include: Network Connected Device 105 (Device 105) used by a data subject; Personal Data Hub 100 (PDH 100), an apparatus of the present invention whose Data Controller is the data subject using Device 105; Querying Recipient 120 (QR 120), a Recipient requesting to be provisioned a generated Processed Data Element attributable to the data subject using Device 105 generated by PDH 100; a QR 120 Network Presence 125 owned, controlled, paid for, or otherwise supported by QR 120; and a network based Supplementary Source Of Data 115 that may provide information to PDH 100 related to the data subject using Device 105, QR 120, or the occurrence of events, where such events include, but are not limited to, real world, cyber, social, economic, legal, or political events.

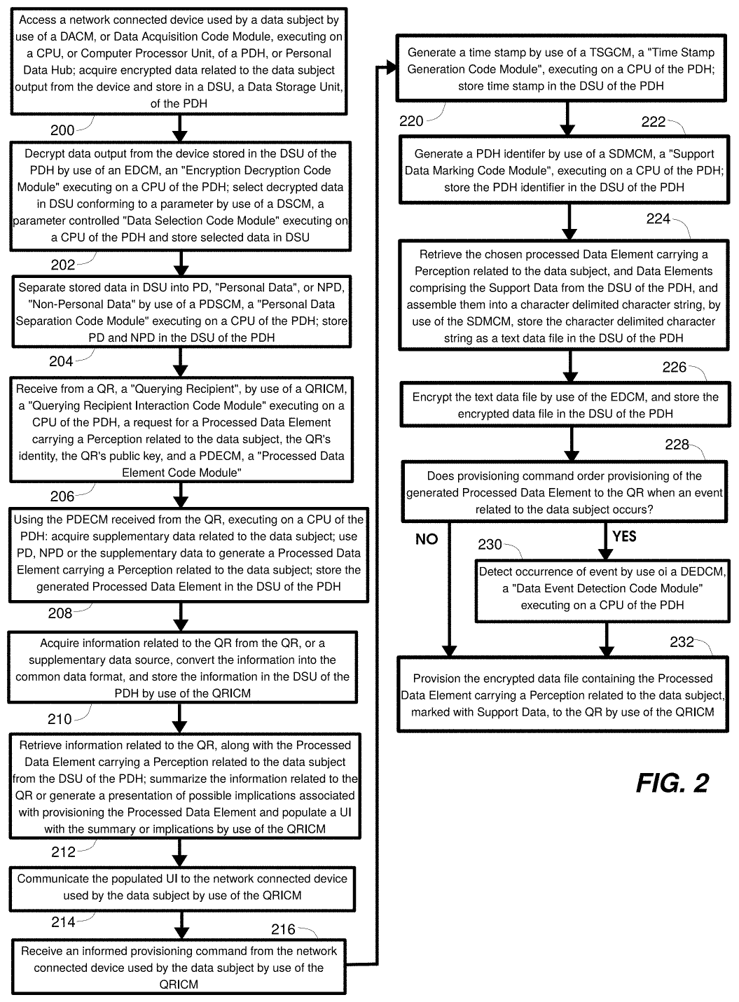

A flowchart of the actions performed by the preferred embodiment of PDH 100, while operating in the environment depicted in FIG. 1, is shown in FIG. 2. Depending on the capabilities offered by the 5 major participants included in the environment of FIG. 1, the actions shown in FIG. 2, as well as the order in which the actions are performed, may differ for other embodiments of PDH 100. However, the major result realized from the actions of other embodiments of PDH 100 of the present invention are to be the same. Specifically, the actions of PDH 100 of the present invention result in the provisioning of a Processed Data Element to QR 120 that has been explicitly commanded to be provisioned to QR 120 by the data subject using the device, Device 105, from which the data used to generate the Processed Data Element, was acquired. QR 120 is thus provided with a Processed Data Element along with explicit consent to use the Processed Data Element for its benefit. FIG. 2 illustrates the series of actions performed to achieve this result by the preferred embodiment of PDH 100.

In Action 200 of FIG. 2, PDH 100 accesses Device 105 used by a data subject by use of a Code Module called a Data Acquisition Code Module (DACM) executing on a Computer Processor Unit (CPU) of PDH 100 using a Network Communications Interface (NCI) incorporated in PDH 100, and acquires data related to the data subject who is using Device 105. This data is made available to PDH 100 through an Applications Program (APP) installed in Device 105, executing on a Device CPU (DCPU) of Device 105. The APP, to be referred in this discussion as a Device Application Program (DAPP), may be downloaded to Device 105 from PDH 100 or from an APP store operated by the manufacturer of Device 105, and stored in a Device Data Storage Unit (DDSU) of Device 105. Such an APP store may, for example, be the “Google Play” store operated by Google LLC, the “App Store” operated by Apple, Inc, the “Mac Store” operated by Apple, Inc, or the “Microsoft Store” operated by Microsoft, Inc. The DAPP may also be incorporated into Device 105 at the time of its manufacture. For a device serving as Device 105, whose purpose is to acquire specific Device 105 user data, as may be the case for an “Internet Of Things” (IOT) device such as a smart thermostat where the temperature of a room at defined times of the day is acquired, a smart refrigerator or smart washing machine where the need to restock a consumable used by the user of Device 105 is detected, or a fitness tracker where the distance run per day by the user of Device 105 is measured, the DAPP incorporated in the device may not need to provide full functionality. For example, such specific data acquisition devices may not need to include software code to operate a two-way Device Information Display (two-way DID) capable of receiving commands from the user of the specific data acquisition device and communicating such commands to PDH 100.

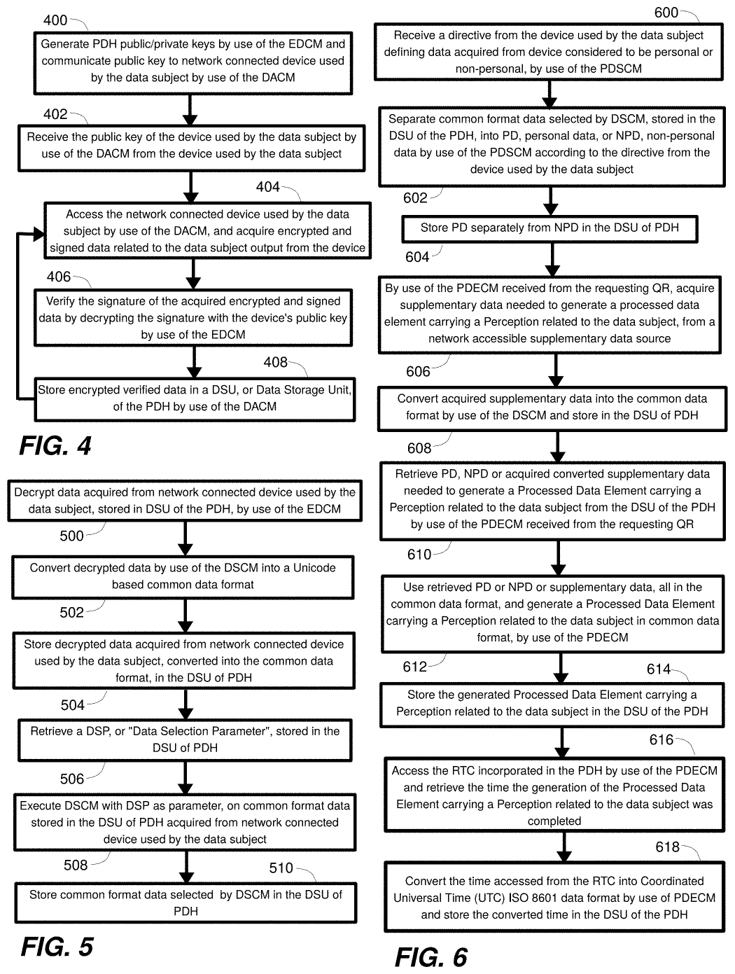

Data acquired from Device 105 are stored in a Data Storage Unit (DSU) of PDH 100 for later processing by a Code Module executing on a CPU of PDH 100. Since the PDH DAPP installed in Device 105 used by the data subject that collects data from the use of Device 105 by the data subject, is designed to collect as much data related to the data subject as possible, including Personally Identifiable Information (PII), such as credit card numbers, or Sensitive Personal Information (SPI), such as health related information, it is necessary, for reasons of security and privacy, for the data to be communicated to PDH 100 in an encrypted form. The preferred embodiment of PDH 100 utilizes public/private key encryption to effect this encryption, although other forms of encryption may be used. To allow the PDH DAPP installed in Device 105 to effect such encryption, the public key of PDH 100 is communicated from PDH 100 to the DAPP incorporated in Device 105 by the DACM executing on a CPU of PDH 100. The DAPP uses the PDH 100's public key to encrypt the user of Device 105's personal or non personal data so that it may only be decrypted by PDH 100, thus allowing Device 105 to communicate the data attributable to the user of Device 105 to PDH 100 over a public network, such as the Internet, with security and privacy. PDH 100 uses its private key to decrypt the data received from Device 105. For additional security the PDH DAPP installed in Device 105 may communicate the DAPP's public key to PDH 100 and sign the encrypted personal or non personal data attributable to the user of Device 105 to the DAPP's private key. In this case, PDH 100 would use the DAPP's public key to decrypt, and thus verify, the DAPP's signature. This assures that the data related to the user of Device 105 was actually communicated to PDH 100 from Device 105. Action 200 of FIG. 2 is illustrated in detail in FIG. 4.

In Action 400 of FIG. 4, an Encryption Decryption Code Module (EDCM) incorporated in PDH 100 executing on a CPU of PDH 100 is called by the DACM, generates PDH 100 public and private keys, and stores PDH 100's public and private keys in the DSU of PDH 100. In the preferred embodiment of PDH 100, the EDCM may use “Gnu Privacy Guard” or GnuPG, as well as other public/private key software encryption programs, to effect the generation of PDH 100's public and private keys, the decryption of data received from Device 105 related to the data subject using Device 105, and the encryption of the generated Processed Data Element carrying a Perception related to the data subject using Device 105 generated by PDH 100 from data received from Device 105, prior to the generated Processed Data Element being provisioned to QR 120. The DACM, executing on a CPU of PDH 100, then communicates PDH 100's public key to Device 105 by use of the NCI incorporated in PDH 100. In Action 402, PDH 100 receives Device 105's public key from Device 105, by use of the DACM executing on a CPU of PDH 100, and the DACM stores Device 105's public key in the DSU of PDH 100. The DACM then, in Action 404, accesses Device 105 used by the data subject and acquires data related to the data subject that is encrypted to PDH 100's public key and signed to Device 105's private key by the DAPP executing on a DCPU of Device 105. In Action 406 the signature of the encrypted data acquired from Device 105 is verified by the EDCM called by the DACM, by use of Device 105's public key. In Action 408 the encrypted and verified data related to the data subject is securely stored in the DSU of PDH 100 by use of the DACM. Actions 404 through 408 are then continuously repeated in order to acquire and store fresh data related to the data subject. The acquisition of data related to the data subject may be initiated: on a timed basis, for example every 5 minutes; when an event occurs, such as when the data subject using Device 105 is exercising as reported by a motion sensor incorporated in Device 105; or when Device 105 is located at a particular physical location as reported by a Global Positioning System incorporated in Device 105.

In Action 202 of FIG. 2, data related to the data subject using Device 105, stored in the DSU of PDH 100, are selected by a Data Selection Code Module (DSCM) executing on a CPU of PDH 100, in accordance with a “Data Selection Parameter” (DSP) input to the DSCM. Data selection prior to further processing may significantly increase the speed of subsequent Processed Data Element processing by reducing the quantity of data needed to effect such processing. A DSP may be provided to PDH 100, for example, by QR 120, or by the manufacturer of PDH 100. Action 202 of FIG. 2 is illustrated in detail in FIG. 5.

As can be seen from Action 500 of FIG. 5, encrypted data acquired from Device 105 used by the data subject, stored in the DSU of PDH 100, is decrypted using PDH 100's private key by use of the EDCM called by the DSCM. In Action 502, the resulting unencrypted data is input to the DSCM where it is converted into a common data format. In the preferred embodiment of PDH 100, the unencrypted data is converted to the 8 bits per data unit “Unicode Transformation Format” (UTF-8) Character Encoding Scheme (CES), although another CES may be employed. This conversion may be effected by the DSCM calling a series of open source programs. Commercially available programs, custom programs, or custom algorithms integrated into the DSCM, may be used as well. Since the data acquired from Device 105 may be comprised of a number of different data types, a number of different conversion programs may be required to convert all the acquired data to the UTF-8 common data format. These data types may include, but are not limited to, text data using more than one CES, image data, word processing document data, spreadsheet document data, or HTML encoded web page data. In the case of acquired text data, for example, the conversion to the UTF-8 common data format used by PDH 100 may be best effected by a program that recognizes the CES used by the characters comprising a particular acquired text Data Element. One program that can accomplish this conversion is “mixconv Version 20160905-1+b1”. The mixconv program can read an acquired Data Element, analyze the Data Element to determine whether it utilizes 7-bit ASCII character encoding, 8-bit ASCII character encoding, UTF-8 character encoding, or “Wobbly Transformation Format-8-bit” (WTF-8) character encoding, an extension of UTF-8, convert the characters comprising the Data Element to UTF-8, and output the result. If the Data Element is comprised of word processing or spreadsheet document data, the program “catdoc Version 1:0.94.3-git20160113.dbc9ec6+dfsg-1+deb9u1” may be used. The catdoc program reads a Microsoft Word, Excel, or Powerpoint file and extracts text contained in file. The extracted text is output from catdoc as ASCII text so the DSCM may pipe the output of catdoc to mixconv to convert the catdoc ASCII output to UTF-8. Like wise the html2text Version Vr−1.3.2a-18+b2 program may be called by the DSCM to convert a HTML text page to ASCII text. As in the case of catdoc, the output of html2text may be piped to mixconv to convert html2text ASCII output to UTF-8. In the preferred embodiment of PDH 100, image data may be analyzed to detect objects or recognize faces in the image data and output text describing such objects or faces. It is this text that the DSCM would convert to UTF-8. In this case, the DSCM may call algorithms from the Open Computer Vision library provided by the University at Buffalo, the State University of New York. Their OpenCV Reference Manual Release 2.4.13.7, published on line on Dec. 13, 2018, describes the computer vision algorithms available in the library for execution under the Linux, Mac OS X, and the Windows operating systems, in great detail.

In Action 504, the decrypted data acquired from Device 105 used by the data subject, that has been converted into the UTF-8 common data format, is stored in the DSU of PDH 100. Following Action 504, in Action 506, a Data Selection Parameter (DSP) stored in the DSU of PDH 100 is retrieved. As previously discussed, this DSP controls the selectivity of the DSCM. A DSP that causes the DSCM to select the portion of the converted decrypted data acquired from Device 105, when Device 105: was at particular physical location; was at a particular physical location when a particular weather condition was in effect; was accessing a particular set of URL or network addresses, or was in use at a particular time of day, may significantly reduce the quantity of data acquired from Device 105 required to effect meaningful Processed Data Element processing. A DSP received from QR 120 may be of particular value, for it has the potential of customizing a generated Processed Data Element to the interests of QR 120. There are many open source data selection programs that can be called by the DSCM to effect the selection of data from a UTF-8 source of data. Commercially available programs, custom programs, or custom algorithms integrated into the DSCM, may be used as well. Tre-agrep 0.8.0-6 is just one open source program that may be use by the preferred embodiment of PDH 100. Using tre-agrep, the DSCM, executing on a CPU of PDH 100, would convert the DSP retrieved from the DSU of PDH 100 into a regular expression and call tre-agrep. The DSP regular expression would be input to tre-agrep and cause tre-agrep to only output data input to tre-agrep that conforms to the selection criteria defined by the DSP regular expression. In the case of the preferred embodiment of PDH 100, the data input to the tre-agrep program would be data acquired from Device 105 converted to the UTF-8 common data format, retrieved from the DSU of PDH 100. The selected output data from Device 105 would then be stored in the DSU of PDH 100. These actions are depicted in FIG. 5 Actions 508 and 510.

In Action 204 of FIG. 2, the acquired Device 105 data that has been decrypted, converted to the common data format used by PDH 100, selected, and stored in the DSU of PDH 100 by Action 202, is separated into PD, “Personal Data” (PD), or “Non-Personal Data” (NPD). A “Personal Data Separation Code Module” (PDSCM) executing on a CPU of PDH 100 is used to effect this separation and store the resulting PD and NPD in the DSU of PDH 100 in separate files, allowing each to be individually accessed by subsequent acts of processing. Action 204 of FIG. 2 is illustrated in detail in Actions 600 through 604 of FIG. 6.

As can be seen from Action 600 of FIG. 6, a directive from Device 105 used by the data subject may be received by the PDSCM, by use of the NCI of PDH 100, defining data acquired from Device 105 considered to be personal or non-personal by the user of Device 105. The receipt of such a directive is not strictly required for the proper operation of the preferred embodiment of PDH 100. The definition of the data considered to be PD or NPD may be incorporated in PDH 100 at the time of PDH 100 manufacture, and subsequently updated by the manufacturer of PDH 100 as new privacy regulations come into force in various jurisdictions. Alternatively, the data acquired from Device 105 may be used with no separation for subsequent acts of processing. However, providing a means for the data subject using Device 105 to express their desires as to what data acquired from their use of Device 105 is considered personal or non-personal, allows the user of Device 105 to have more control over the implications of a generated Processed Data Element that the user of Device 105 may command to be provisioned to QR 120.

In Action 602, selected acquired data from Device 105 in the PDH 100 UTF-8 common data format, stored in the DSU of PDH 100, are separated into PD or NPD by the PDSCM, according to the directive from the user of Device 105, the directive indicating the Data

Elements the user of Device 105 deems personal. Such separation may be effected by a program called by the PDSCM. In the preferred embodiment of PDH 100 one such program that may be used is tre-agrep 0.8.0-6. In this case, to obtain the NPD contained in the data from Device 105, a series of regular expressions are generated by the PDSCM based on the received directive, each regular expression causing tre-agrep to only output the portion of the data input to tre-agrep that does not conform to the regular expression, thus removing data considered personal by the user of Device 105 from tre-agrep's output. This result is effected by calling tre-agrep with the “-v” or “—invert-match” option, which causes tre-agrep to invert the sense of matching and only output non-matching Data Elements. The PDSCM repeatedly calls tre-agrep with the “-invert-match” option, each call using a regular expression matching a different Data Element deemed by the user of Device 105 to be personal, while inputting Device 105 data to tre-agrep. This results in tre-agrep outputting Data Elements considered by the user of Device 105 to be non-personal. Next, to cause tre-agrep to output Data Elements considered by the user of Device 105 to be personal, the PDSCM repeatedly calls tre-agrep without the “-invert-match” option, each call using a regular expression matching a different Data Element deemed by the user of Device 105 to be personal, while inputting Device 105 data to tre-agrep. This results in tre-agrep outputting Data Elements considered by the user of device 105 to be personal. In Action 604, the PDSCM then generates a non-personal data file containing the NPD Data Elements output from tre-agrep and a personal data file containing the PD elements output from tre-agrep, and stores each file in the DSU of PDH 100. This allows subsequent processing acts to access non-personal data acquired from Device 105 independently from personal data acquired from Device 105 and use the non-personal data and personal data separately, or in combination, to generate a Processed Data Element related to the user of Device 105.

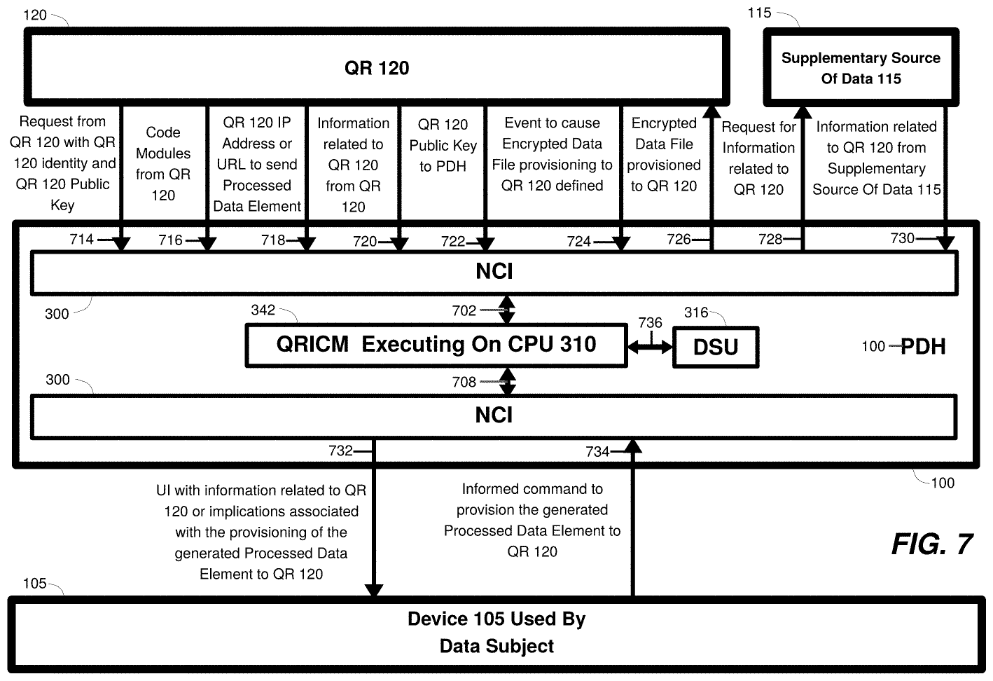

In Action 206 of FIG. 2, a “Querying Recipient Interaction Code Module” (QRICM) executing on a CPU of PDH 100, receives a request from QR 120, along with QR 120's identity and QR 120's public key, for a Processed Data Element carrying a Perception related to the data subject using Device 105, as shown by FIG. 7 Line 714. QR 120's identity and public key is stored in DSU 316 of PDH 100 by use of the QRICM. As indicated by FIG. 7 Line 716, QR 120 may additionally communicate to the QRICM a “Data Selection Code Module” (DSCM), a “Personal Data Separation Code Module” (PDSCM) or a “Processed Data Element Code Module (PDECM) for PDH 100 to use to generate the requested Processed Data Element. QR 120 may also communicate to the QRICM over line 716 a Data Selection Parameter (DSP) for use by the DSCM, whether or not the DSCM was communicated to the QRICM by QR 120. Along with these Code Modules, QR 120 may provide to the QRICM the identity of the company, group, or individual that sourced each of the Code Modules to QR 120 that were communicated to the QRICM. Action 206 of FIG. 2 indicates that in the preferred embodiment of PDH 100 a PDECM is received from QR 120. In Action 208, using the PDECM received from QR 120 executing on a CPU of PDH 100, supplementary data related to the data subject may be acquired from a network accessible Supplementary Source Of Data 115 of FIG. 1 by the PDECM, by use of the NCI incorporated in PDH 100. Such supplementary data is then used by the PDECM in combination with PD or NPD data acquired from Device 105, or by itself, to generate the Processed Data Element carrying a Perception related to the user of Device 105. The resulting generated Processed Data Element, along with the time the generation of the Processed Data Element was completed, is stored in the DSU of PDH 100 by the PDECM from QR 120. Actions 206 and 208 of FIG. 2 are illustrated in detail in Actions 606 through Action 618 of FIG. 6.

In Action 606, supplementary data needed to generate a Processed Data Element carrying a Perception related to the data subject, is accessed from a network accessible supplementary data source by the PDECM received from QR 120, executing on a CPU of PDH 100, by use of the NCI incorporated in PDH 100. As is the case for data acquired from Device 105 used by the data subject, supplementary data acquired from Supplementary Source Of Data 115 may be encoded in a wide range of data formats, so in Action 608, the acquired supplementary data is converted into UTF-8 used as the common data format by PDH 100 and stored in the DSU of PDH 100. In the preferred embodiment of PDH 100, the DSCM executing on a CPU of PDH 100 may be used to effect the conversion, by use of the same process employed to convert data acquired from Device 105 to UTF-8. As is the case for data acquired from Device 105, acquired supplementary data would be input to the DSCM, and the DSCM would call a series of open source programs, each tailored to convert a different data format to the UTF-8 common data format, to effect the conversion. This process is described in more detail as it relates to Action 502 of FIG. 5.

In Action 610, PD, NPD or acquired converted supplementary data needed to generate a Processed Data Element carrying a Perception related to the data subject using Device 105 are retrieved from the DSU of the PDH 100 by use of the PDECM received from QR 120. In Action 612, the retrieved PD, NPD or supplementary data, all in the common data format, are input to the PDECM received from QR 120 and the PDECM generates a Processed Data Element carrying a Perception related to the data subject, in common data format. In Action 614, the generated common data format Processed Data Element is stored by the PDECM in a database structure previously defined in the DSU of PDH 100. Such database structure may have been generated by the PDECM, or another Code Module, at an earlier time. The use of a database structure to store the Processed Data Element carrying a Perception related to the data subject using Device 105 in the DSU, facilitates the retrieval of the Processed Data Element in Action 806, to be later discussed, as well as the maintenance of stored Processed Data Elements as the Processed Data Elements age.

As previously discussed the PDECM may employ, for example, an Artificial Intelligence (AI), Machine Learning (ML), Neural Network (NN), Data Mining (DM), Deep Learning (DL) or other algorithm, to generate from the PD, NPD or supplementary data, a Processed Data Element carrying a Perception that is meaningful to QR 120. Much has been published on such algorithms. For example: “An inference engine for RDF” a masters thesis by Guido Naudts, Open University of the Netherlands, Agfa Gevaert, Oct. 30, 2003, http://www.agfa.com/w3c/2002/02/thesis/thesis.pdf, is a good introduction to the topic of inference engines; “Paradigms of Artificial Intelligence Programming: Case Studies In Common Lisp” by Peter Norvig, Morgan Kaufmann Publishers, San Francisco, Calif., 1992, is a good introduction to artificial intelligence algorithms; and “Data Mining And Analysis: Fundamental Concepts and Algorithms” by Mohammed J. Zaki Rensselaer Polytechnic Institute, Troy, N.Y. and Wagner Meira Jr. Universidade Federal de Minas Gerais, Brazil, Cambridge University Press, 2014 is a good introduction to data mining algorithms.

The use of a PDECM received from QR 120 by PDH 100 for the generation of a Processed Data Element carrying a Perception related to the data subject using Device 105, provides QR 120 with an opportunity to obtain a provisioned Processed Data Element carrying a Perception customized to its needs. To be clear, the present invention does not limit a Recipient, such as QR 120, to providing only a PDECM to PDH 100 for use in the Processed Data Element generation process. Each Recipient who has requested a Processed Data Element carrying a Perception related to the data subject using Device 105 may provide one or more Code Modules for the processing of data acquired from Device 105. Such Code Modules may include a DSCM, a PDSCM or a PDECM, among others. Each Code Module received from the Recipient may be authorized or rejected by the Data Controller of PDH 100 for use as part of the Processed Data Element generation process. In the president invention, the Data Controller of PDH 100 is the data subject whose personal or non-personal data is being processed to generate the Processed Data Element carrying a perception for provisioning to a Recipient. This means that the Data Controller of PDH 100 is the data subject using Device 105. By using Code Modules provided by the Recipient, each Recipient who requests a Processed Data Element carrying a Perception related to the data subject using Device 105 may be provisioned a unique Perception customized to their needs, even though the data subject's acquired data input to the Processed Data Element generation process may be the same. This is because the Perception provisioned to a first Recipient is the result of processing by a first set of Code Modules, while the Perception provisioned to a second Recipient is the result of processing by a second set of Code Modules.

In Action 616 of FIG. 6, a Real-Time Clock (RTC) incorporated in PDH 100 is accessed by use of the PDECM from QR 120, and the time the generation of the generated Processed Data Element carrying a Perception related to the data subject was completed is retrieved. The retrieved time is then converted to a character encoded ASCII text element in the UTC ISO 8601 time format, and stored in the DSU of PDH 100 by use of the PDECM from QR 120, in Action 618. As will be later discussed, this time will be provided to QR 120 in the form of Support Data along with the generated Processed Data Element carrying a Perception related to the data subject.

With reference to FIG. 7, in Action 210, QRICM 342, executing on a CPU 310 of PDH 100, acquires information related to QR 120 that either has been obtained from QR 120, over Lines 714 and 720, or obtained from network connected Supplementary Source Of Data 115 by first querying Data Source 115 over line 728, and then receiving information related to QR 120 over Line 730. QRICM 342 then converts the acquired information related to QR 120 to the common data format used by PDH 100, the UTF-8, and stores the information converted to the common data format in DSU 316 of PDH 100 over line 736. As is the case for data acquired from Device 105, acquired data related to QR 120 would be input to the QRICM, and the QRICM would call a series of open source programs, each tailored to convert a different data format to the UTF-8, to effect the conversion. This process is described in more detail as it relates to Action 502 of FIG. 5. In Action 212, the information related to QR 120, along with the generated Processed Data Element carrying a Perception related to the user of Device 105 to be provisioned to QR 120, is retrieved from DSU 316 over line 736 by QRICM 342. The information related to QR 120 is formatted or summarized by QRICM 342. The Processed Data Element is processed by QRICM 342 to generate a presentation of one or more possible implications associated with the provisioning of the Processed Data Element to QR 120. QRICM 342 then populates a User Interface (UI) generated by QRICM 342 with the information related to QR 120 or the presentation of possible implications. In Action 214, the UI is communicated to Device 105 by the QRICM 342 over Line 732, and is received by the DAPP executing on the DPCU of Device 105, installed in Device 105 in Action 200. The DAPP renders the received UI and displays the UI visually on a screen, acoustically on a speaker or tactually on a touchpad incorporated in Device 105. The user of Device 105 reviews the information presented by the UI and decides whether to respond to QRICM 342 with a command to provision the generated Processed Data Element to QR 120. When the user of Device 105 reviews the information presented, and decides to have the generated Processed Data Element provisioned to QR 120, the user causes the DAPP to communicate a provisioning command to QRICM 342 over Line 734 by use of an input mechanism incorporated in Device 105. In Action 216, QRICM 342, by the use of NCI 300 incorporated in PDH 100, receives, over Lines 734 and 708, the provisioning command from the user of Device 105.

Before the generated Processed Data Element commanded to be provisioned to QR 120 by the user of Device 105 is provisioned, the generated Processed Data Element is first packaged to facilitate QR 120's use of the provisioned data. In the preferred embodiment of PDH 100, such packaging is comprised of the generation of a text data file in the common data format used by PDH 100 that contains the generated Processed Data Element marked with Support Data, and the encryption of the generated text data file to QR 120's public encryption key. In Action 220 of FIG. 2, a first element of Support Data is prepared. This first element is a time stamp carrying the time at which the generated Processed Data Element related to the user of Device 105, commanded to be provisioned to QR 120 by the user of Device 105, was generated by the PDECM from QR 120 executing on CPU 310 of PDH 100. In Action 220, the time stamp is generated by the use of a “Time Stamp Generation Code Module” (TSGCM) executing on CPU 310 of PDH 100. The TSGCM stores the generated time stamp in DSU 316 of PDH 100. Action 220 of FIG. 2 is illustrated in detail in Actions 800 through 802 of FIG. 8. In Action 800, the TSGCM retrieves from DSU 316 of PDH 100 the time the generation of the chosen Processed Data Element carrying a Perception related to the data subject was completed. The retrieved time is in the form of a character encoded ASCII text element in the UTC ISO 8601 time format. In Action 802, the TSGCM generates a time stamp in PDH 100 UTF-8 common data format from the retrieved UTC ISO 8601 ASCII time data and stores the time stamp in DSU 316. Recall that in Actions 616 through 618 Processed Data Element generation completion time was obtained from the RTC of PDH 100 and stored in DSU 316 in the UTC ISO 8601 time format by the PDECM executing on CPU 310. Since the retrieved time is in the form of a character encoded ASCII text element, the TSGCM may call the program “mixconv” to generate a time stamp in PDH 100 UTF-8 common data format from the retrieved UTC ISO 8601 ASCII time data. The discussion of Action 502 of FIG. 5 provides more details as to how mixconv can be used to effect this generation.

In Action 222 of FIG. 2, a PDH Identifier, a second element of Support Data, is generated by use of a “Support Data Marking Code Module” (SDMCM) executing on CPU 310 of PDH 100. As will be later discussed, a PDH Identifier may be used by QR 120 to determine when Device 105 is in communication with an network address owned, controlled, used, or accessed by QR 120. Action 222 of FIG. 2 is now discussed in detail with reference to Action 804 of FIG. 8. In Action 804, the SDMCM generates the PDH Identifier in the common data format used by PDH 100, UTF-8. The generation of a PDH Identifier may be effected by the use of an open source identifier generator. A commercial identifier generation program, a custom identifier generation program, or a custom identifier generation algorithm integrated into the SDMCM may also be used. “uuid 1.6.2” is one such open source program that can be used by the SDMCM to generate the PDH Identifier. To generate the PDH Identifier, the SDMCM would call uuid 1.6.2 with the command line uuid-v4-F STR|mixconv to generate a random “Universally Unique Identifier” (UUID) as an ASCII text string and pipe the generated ASCII text string to the mixconv program, previously discussed in relation to Action 502 of FIG. 5, to convert the ASCII text string to the UTF-8 common data format used by PDH 100. The resulting PDH Identifier is stored in DSU 316 of PDH 100 by the SDMCM.

The SDMCM also communicates the PDH Identifier to the DAPP installed in Device 105 by use of NCI 300 incorporated in PDH 100. This allows the DAPP to include the PDH Identifier in the data stream communicated to an network address visited by the Device 105. By monitoring their network presences, QR 120 can determine when Device 105 is in communication with a network address owned, controlled, used, or accessed by QR 120. QR 120 can make this determination by comparing the PDH Identifier communicated by Device 105 to the visited network address with the PDH Identifier incorporated as Support Data in the text data file containing the generated Processed Data Element related to the user of Device 105 provisioned to QR 120 by PDH 100.

In Action 224 of FIG. 2, the chosen generated Processed Data Element to be provisioned to QR 120 by PDH 100, and Data Elements comprising the Support Data that the generated Processed Data Element is to be marked with, are retrieved from the DSU 316 of PDH 100 by use of the SDMCM executing on CPU 310 of PDH 100. They are then assembled into a character delimited character string by use of the SDMCM, and the resulting character delimited character string is stored as a text data file in DSU 316 of PDH 100. It is this text data file that is provisioned to QR 120 by PDH 100. Action 224 is illustrated in detail in Actions 806 through 810 of FIG. 8.

In Action 806 of FIG. 8, the chosen generated Processed Data Element to be provisioned to QR 120, the time stamp carrying the time the chosen generated Processed Data Element was generated, information related to QR 120, and the PDH identifier, are retrieved from DSU 316 of PDH 100. All of these Data Elements are in the form of UTF-8 character strings. The SDMCM then adds a label to each Data Element by appending a unique character included in the UTF-8 character set, but not included in the character string comprising the Data Element, to the beginning of the Data Element. The label describes the information carried by the Data Element. The labeled Data Elements are then stored in DSU 316 of PDH 100 by the SDMCM.

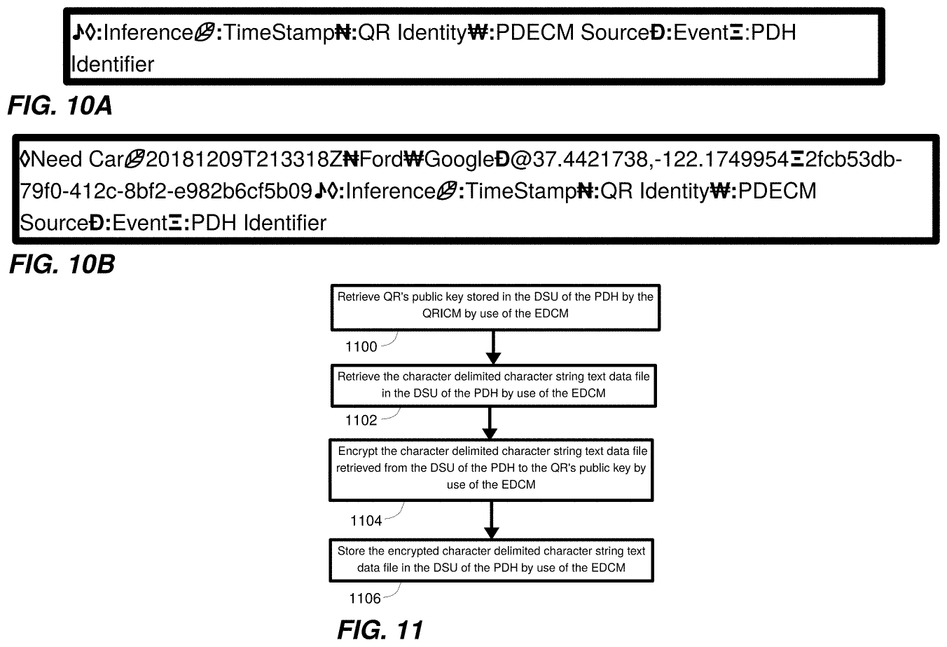

In Action 808, the SDMCM generates an Indexing Data Element that provides QR 120 with the data needed to comprehend the meaning of the labels appended to the other Data Elements. This Data Element is comprised of a unique first delimiting character, indicating the following character string is an Indexing Data Element, a first label character to be defined, a link UTF-8 character, such as a colon, a UTF-8 character string that defines the meaning of the first label character, a second label character to be defined, the link UTF8 character, a UTF-8 character string that defines the meaning of the second label character, a third label character to be defined, the link UTF-8 character, a UTF-8 character string that defines the meaning of the third label character, and so forth. The generated Indexing Data Element is then stored in DSU 316 of PDH 100 by the SDMCM. FIG. 10A depicts a UTF-8 character string that comprises an example Indexing Data Element generated by the SDMCM of the preferred embodiment of PDH 100.

In Action 810, the SDMCM assembles the labeled chosen generated Processed Data Element carrying a Perception related to the data subject, the labeled time stamp, the labeled information related to the QR, the labeled PDH identifier, and the Indexing Data Element, retrieved from DSU 316 of PDH 100, into a UTF-8 character delimited character string, and stores the assembled character string as a text data file in DSU 316 of PDH 100. FIG. 10B is an illustration of an example UTF-8 character string assembled by the SDMCM. It can be seen from FIG. 10B that characters 1, 10, 27, 32, 39, 64, 101, 102, 103, 113, 114, 124, 133, 134, 146, 148, 154, and 155 in the character string may serve as labels, delimiters, or links. Being in the first position of the character string, character 1 of FIG. 10B, “⋄”, is a label. This label indicates that the following UTF-8 characters provide information pertaining to an inference generated from personal or non personal data acquired from Device 105, by use of the PDECM provided to the PDH 100 from QR 120. The generated inference, “need car”, indicates that the user of Device 105 may have a need to purchase, or acquire the use of a car. We know that the “⋄” character precedes the description of an inference in the character string because the index Data Element, which follows the index Data Element label character “ [symbol] ” in character position 101 of the character string, linked the “⋄” character to the term “inference” by use of the link character “:”. Character 10 in the character string, “ [symbol] ”, serves as both a delimiter and a label. It separates the following character string from the generated inference that precedes it, while labeling the following character string as a time stamp Data Element. The time stamp shown indicates that the preceding inference was generated on Dec. 9, 2018 at 21:33:18 Coordinated Universal Time (UTC). We know that the “ [symbol] ” character precedes a time stamp in the character string because the index Data Element linked the “ [symbol] ” character to the term “TimeStamp” by use of the link character “:”. Character 27 in the character string, “ [symbol] ”, serves as both a delimiter and a label. It separates the following character string from the time stamp description that precedes it, while labeling the following character string as a QR Identity Data Element. The QR Identity Data Element shown indicates that the preceding inference was asked for by the “Ford Motor Company”. We know that the “ [symbol] ” character precedes a QR Identity Data Element character string because the index Data Element linked the “ [symbol] ” character to the term “OR Identity” by use of the link character “:”. Character 32 in the character string, “ [symbol] ”, serves as both a delimiter and a label. It separates the following character string from the QR Identity description that precedes it, while labeling the following character string as a PDECM Source Data Element. The PDECM Source Data Element shown indicates that the preceding inference was generated by a PDECM sourced by “Google LLC”. We know that the “ [symbol] ” character precedes a PDECM Source character string because the index Data Element linked the “ [symbol] ” character to the term “PDECM Source” by use of the link character “:”. Character 39 in the character string, “ [symbol] ”, serves as both a delimiter and a label. It separates the following character string from the PDECM Source description that precedes it, while labeling the following character string as an Event Data Element. The Event Data Element shown indicates that the provisioning of the preceding inference to the identified QR, in this case the Ford Motor Company, was initiated by the event of Device 105 being located at the GPS coordinates “37.4421738, −122.1749954”. This is the GPS coordinates of the Tesla Inc. dealership at the Stanford Shopping Center in Palo Alto, Calif. We know that the “ [symbol] ” character precedes an Event character string because the index Data Element linked the “ [symbol] ” character to the term “Event” by use of the link character “:”. Character 64 in the character string, “ [symbol] ”, serves as both a delimiter and a label. It separates the following character string from the Event description that precedes it, while labeling the following character string as a Personal Data Hub (PDH) Identifier Data Element. The PDH Identifier Data Element shown indicates that the preceding inference provisioned to the identified QR, the Ford Motor Company, was provisioned by a particular Personal Data Hub (PDH), in this case the PDH identified by the UUID 2fcb53db-79f0-412c-8bf2-e982b6cf5b09. We know that the “ [symbol] ” character precedes a PDH Identifier character string because the index Data Element linked the “ [symbol] ” character to the term “PDH Identifier” by use of the link character “:”. Character 101 in the character string, “ [symbol] ”, serves as a delimiter and a label. It separates the following character string from the PDH Identifier character string that precedes it, while labeling the following character string as an Indexing Data Element. In the preferred embodiment of PDH 100, the “ [symbol] ” character is predefined to indicate that the characters following its occurrence are those of an Indexing Data Element, although other delimiting characters may be used. At the completion of Action 810, the SDMCM stores the assembled character string as a text data file in DSU 316 of PDH 100.

In Action 226 of FIG. 2, the text data file assembled in Action 224 to be provisioned to QR 120, is retrieved form DSU 316 of PDH 100, and encrypted to QR 120's public key by use of a “Encryption Decryption Code Module” (EDCM). The encrypted file is stored in DSU 316 of the PDH 100 for later provisioning to QR 120. Action 226 is illustrated in detail in Actions 1100 through 1106 of FIG. 11. In Action 1100, QR 120's public key, stored in the DSU of the PDH by the QRICM in Action 206, is retrieved by use of the EDCM. The text data file to be provisioned to QR 120 is then retrieved from DSU 316 of PDH 100 by use of the EDCM, in Action 1102. In Action 1104 through 1106, the text data file to be provisioned to QR 120 is encrypted to QR 120's public key, and stored in DSU 316 of PDH 100, by use of the EDCM.

At Action 228 of FIG. 2, the data comprising the text data file commanded to be provisioned to QR 120 by the user of Device 105, has been acquired, converted to the UTF-8 common data format used by PDH 100, processed as taught by the present invention, and encrypted to QR 120's public key. At this point in the present invention's process flow, the text data may be provisioned to QR 120. However, if the provisioning command from the user of Device 105 includes an order to provision the generated Processed Data Element carrying a Perception relating to the user of Device 105 to QR 120 at the occurrence of an event, such an event needs to be detected prior the text data file being provisioned. In Action 228, whether or not the provisioning command includes the directive to provision the text data file when an event occurs, is determined. If it does, process flow continues to Action 230 of FIG. 2. If it does not, process flow continues to Action 232 of FIG. 2.

In Action 232 of FIG. 2, since no event has been directed to be detected, The encrypted text data file, containing the generated Processed Data Element related to the user of Device 105, marked with Support Data, is provisioned, over Line 726 of FIG. 7, by use of the QRICM, to the network address or URL provided to the QRICM by QR 120 over Line 718 of FIG. 7.

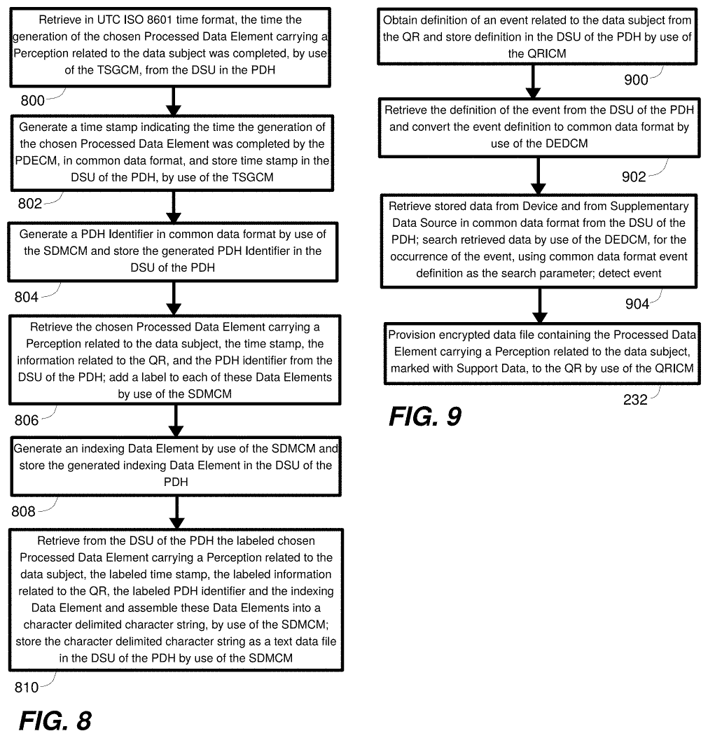

In Action 230 of FIG. 2, the occurrence of the event defined by QR 120, and communicated to the QRICM of PDH 100 over line 724 of FIG. 7, is detected by a “Data Event Detection Code Module” (DEDCM) executing on CPU 310 of PDH 100. Process flow continues to Action 232 where the encrypted text data file containing the generated Processed Data Element related to the user of Device 105, marked with Support Data, is provisioned to QR 120 by use of the QRICM. Action 230 is illustrated in detail in Actions 900 through 904 of FIG. 9.

In Action 900 of FIG. 9, the QRICM obtains the definition of an event from QR 120 and stores the event definition in DSU 316 of PDH 100. In Action 902, the event definition is retrieved from DSU 316 of PDH 100 and converted to the UTF-8 common data format used by PDH 100 by use of the DEDCM. As previously discussed in relation to Action 502, the open source program “mixconv” can be used for this purpose. Stored data from Device 105 and Supplementary Source Of Data 115, previously converted to the UTF-8 common data format of PDH 100, is then retrieved from DSU 316 of PDH 100 and searched in Action 904 by a data selection program called by the DEDCM, for the occurrence of the event, using the UTF-8 converted event definition as the search parameter. When a match occurs, the matched data string is output from the data selection program indicating to the DEDCM that the event has occurred. PDH 100 may call an open source data selection program, such as “tre-agrep”, as discussed in relation to Action 504, as the data selection program, although commercially available data selection programs, custom data selection programs, or a custom data selection algorithm integrated into the DEDCM may also be used for this purpose. In the case of a defined “compound event”, that is the occurrence of two or more separate events needing to take place for the DEDCM to determine that the event has occurred, the data selection program may be called multiple times, with different search parameters, by the DEDCM. When the DEDCM determines that the event has occurred, process flow proceeds to Action 232, where the encrypted text data file containing the generated Processed Data Element related to the user of Device 105, marked with Support Data, is provisioned to QR 120 by use of the QRICM.

The UTF-8 character string shown in FIG. 10B, includes an event Data Element, [symbol] @37.4421738, −122.1749954, that can serve as an example of an event definition that may be detected by the DEDCM. In the context of Actions 230 and 232 of FIG. 2, the occurrence of this event Data Element in data acquired from Device 105, directs the encrypted text data file containing the marked Processed Data Element related to the user of Device 105, commanded to be provisioned to QR 120 by the user of Device 105, to be provisioned to QR 120 when Device 105 is located at the GPS coordinates “37.4421738, −122.1749954”. These are the GPS coordinates of the Tesla Inc. dealership at the Stanford Shopping Center in Palo Alto, Calif. Using tre-agrep as the data selection program called by the DEDCM, with GPS coordinates “37.4421738, −122.1749954” as the search string parameter, causes tre-agrep to output a match when the user of Device 105 is located at the Stanford Shopping Center Tesla dealer. This match results in the QRICM provisioning to QR 120, the encrypted marked text data file containing the generated Processed Data Element related to the user of Device 105. The processed data related to Device 105's user may be then employed by QR 120 to support the organization's activities while Device 105's user is located at the Tesla dealer.

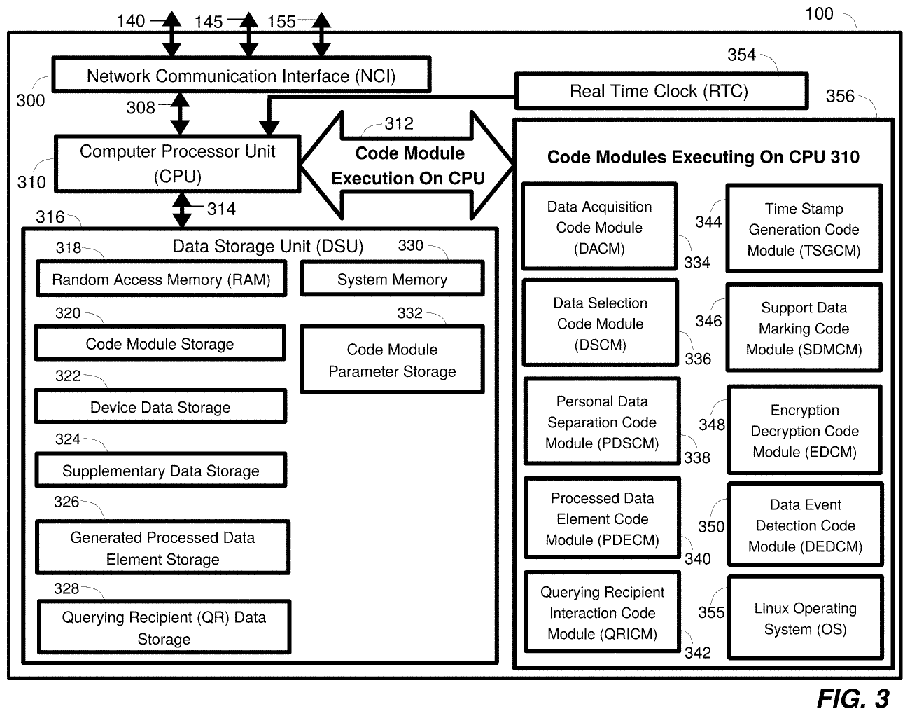

The configuration of PDH 100 will now be discussed. FIG. 3 is a block diagram that depicts components comprising an embodiment of PDH 100 of the present invention. Referring to FIGS. 1 and 3, PDH 100 interacts with the participants in the data environment depicted in FIG. 1 over 3 lines, Lines 140, 145 and 155. Data communicated to PDH 100 from Device 105 over Line 155 includes, but is not limited to: data acquired by Device 105 related to the user of Device 105, where such user is the data subject who is the Data Controller of PDH 100; Device 105's Public Key; and commands or directives from the user of Device 105. Such commands or directives include: a command to provision a Processed Data Element related to the user of Device 105 to QR 120; a command that causes PDH 100 to provision such a Processed Data Element to QR 120 when an event occurs; a command to not provision such a Processed Data Element to QR 120, a command to change the PDH 100's Identifier to one unrelated to PDH 100's current Identifier; and a directive defining data acquired from Device 105 considered to be personal or non-personal by the user of Device 105. Data communicated from PDH 100 to Device 105 over Line 155 includes, but is not limited to: PDH 100's Public Key; QR 120's identity; data related to QR 120; the identity of the provider who sourced PDECM 340 used to generate the Processed Data Element related to the user of Device 105; and information relating to the generated Processed Data Element associated with the user of Device 105, generated by PDECM 340 executing on CPU 310 of PDH 100.

Data communicated to PDH 100 from QR 120 over Line 140 includes, but is not limited to: a request from QR 120 for a Processed Data Element that relates to the user of Device 105; QR 120's identity; QR 120's Public Key; the Data Selection Parameter (DSP) QR 120 wants Data Selection Code Module (DSCM) 336 to use for the selection of the portions of data acquired from Device 105 that QR 120 deems to be relevant to their current needs; the Processed Data Element Code Module (PDECM) that QR 120 wants PDH 100 to use for PDECM 340 for the generation of the Processed Data Element; the identity of the company, group, or individual that sourced the PDECM QR 120 wants PDH 100 to use; the network address or URL to which QR 120 wants PDH 100 to provision the generated Processed Data Element related to the user of Device 105; information related to QR 120; and the definition of the event that is to cause PDH 100 to provision to QR 120 the text data file requested by QR 120, the text data file being comprised of the generated Processed Data Element related to the user of Device 105 marked with Support Data, and encrypted to QR 120's public key. Data communicated from PDH 100 to QR 120 over Line 140 includes, but is not limited to, the encrypted text data file requested by QR 120. Note that Lines 714, 716, 718, 720, 722, 724, and 726 of FIG. 7, in aggregate, comprise Line 140 of FIG. 3.

Data communicated to PDH 100 from Supplementary Source Of Data 115 over Line 145 includes, but is not limited to: information related to QR 120 requested by PDH 100; and information related to the user of Device 105 requested by PDH 100. Data communicated from PDH 100 to Supplementary Source Of Data 115 over Line 145 includes, but is not limited to: a request for information related to QR 120; and a request for information related to the user of Device 105.

Process Arrow 312 of FIG. 3 indicates that Code Modules 356 are executed on CPU 310 of PDH 100. These Code Modules may be executed in parallel or serially depending on the configuration of CPU 310, and the availability of data acquired by, or communicated to, PDH 100 by use of NCI 300. In the preferred embodiment of PDH 100: Data Acquisition Code Module (DACM) 334 acquires data from Device 105 used by the data subject who is the Data Controller of PDH 100; Data Selection Code Module (DSCM) 336 selects data from the data acquired from Device 105 in accordance with a Data Selection Parameter (DSP) provided by QR 120; Personal Data Separation Code Module (PDSCM) 338 separates the selected acquired data in Personal Data (PD) and Non-Personal Data (NPD) parts; Processed Data Element Code Module (PDECM) 340 processes the PD or NPD parts of the selected acquired data and generates a Processed Data Element related to the user of Device 105; Querying Recipient Interaction Code Module (QRICM) 342 interfaces with QR 120 and obtains data and software code related to the processing of data acquired from Device 105, and the provisioning of the results of such processing; Time Stamp Generation Code Module (TSGCM) 344, using time data output from Real-Time Clock (RTC) 354, generates a time stamp used to mark data contained in the text data file commanded to be provisioned to QR 120 by the user of Device 105 with the time at which the generated Processed Data Element included in the text data file was generated by PDECM 340; Support Data Marking Code Module (SDMCM) 346 marks data contained in the text data file commanded to be provisioned to QR 120 by the user of Device 105 with Support Data; Encryption Decryption Code Module (EDCM) 348 encrypts the text data file commanded to be provisioned to QR 120 by the user of Device 105 to the Public Key of QR 120; Data Event Detection Code Module (DEDCM) 350 detects the occurrence of an event defined by QR 120 and causes the encrypted text data file commanded to be provisioned to QR 120 by the user of Device 105 to be provisioned to QR 120; Linux Operating System (OS) 355 serves as the executive program under which Code Modules 356 operate.

Data Storage Unit (DSU) 316 of the preferred embodiment of PDH 100, serves as the central repository for data stored and processed by PDH 100. Acquired data and Public Keys from Device 105 are stored in Device Data Storage 322; data and Public Keys provided to PDH 100 from QR 120 are stored in Querying Recipient (QR) Data Storage 328; supplementary data related to QR 120 and the user of Device 105 are stored in Supplementary Data Storage 324; generated Processed Data Elements related to the user of Device 105 are stored in Generated Processed Data Element Storage 326; Linux Operating System software code, and the software code for the programs that run under Linux, are stored in Systems Memory 330; transient processing and operating system data are stored in Random Access Memory (RAM) 318; Code Modules 356 executable code are stored in Code Module Storage 320; and parameters used by Code Modules 356 are stored in Code Module Parameter Storage 332. The aggregate amount of data that may be stored over time by DSU 316 is quite large, thus the preferred embodiment of PDH 100 may use one or more large format 25 or more Terabyte hard disk drives for non-volatile storage, and 32 Gigabytes or more of RAM for transient storage. DSU 316 may use Solid State Drives (SSD) in place of, or in addition to, hard disk drives for non-volatile storage.

Although the preferred embodiment of PDH 100 employs the memory partitioning shown, other memory partitioning configurations may be used. The choice of the memory partitioning configuration is effected by the number and type of processing engines that comprise CPU 310. In the simplest case, a single general purpose microprocessor, such as a Ryzen 7 2700X 8 core processor manufactured by Advanced Micro Devices (AMD) may, for example, be chosen for use as CPU 310. Although this device operates using a clock frequency of 3700 MHz, its basic architecture conforms to the microprocessor x64 architecture used for general computing. Therefore, one or more special purpose processing engines may be incorporated in CPU 310, along with a general purpose microprocessor, to address the need to process large quantities of data acquired from Device 105 and generate Processed Data Elements related to the user of Device 105 in an acceptable period of time. In this case, the general purpose microprocessor may be tasked with hosting Linux Operating System 355, and coordinating the processing activities of the one or more additional special purpose processing engines. Special purpose processing engines that may be used by PDH 100 are, for example, the Graphcore Colossus GC2 Processor, or the NVIDIA Tesla V100 GPU Accelerator.

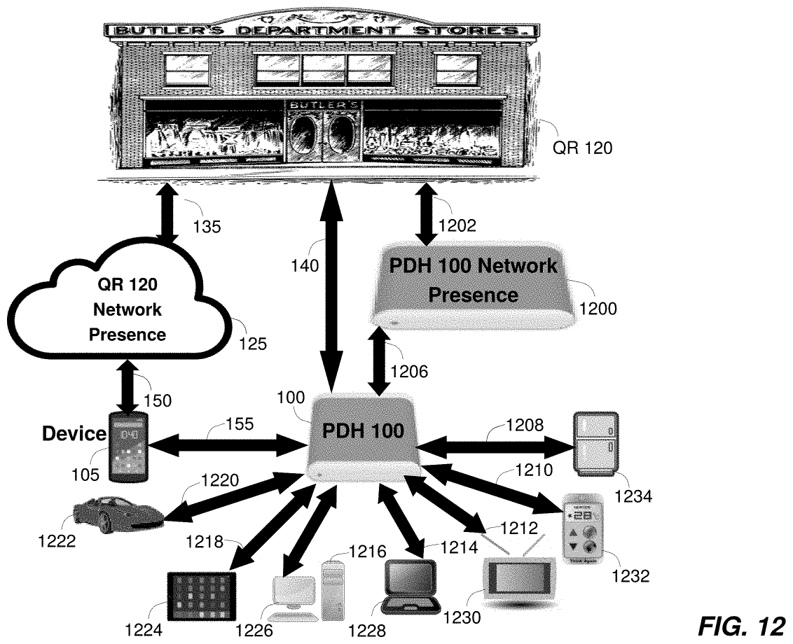

Turning now to the system aspects of the present invention, PDH 100, Device 105, and QR 120 of FIG. 12, comprise a system of the present invention. In FIG. 12 a Recipient, QR 120, is provisioned a Processed Data Element generated by PDH 100 over Line 140 that carries a Perception related to a data subject, the data subject being the user of Device 105 who also is the Data Controller of PDH 100. Before a Processed Data Element can be provisioned to QR 120 from PDH 100, QR 120 needs to communicate with PDH 100 and request that PDH 100's Data Controller provision a Processed Data Element to QR 120. For such communication to occur QR 120 must first be made aware of the network presence of PDH 100; second, be network connected to PDH 100; and third be provided with information related to a Perception carried by a Processed Data Element from PDH 100. Such information may, for example, be a description of categories into which characteristics of a Perception carried by a Processed Data Element from PDH 100 may be placed. The information can be used by QR 120 to determine if QR 120 has an interest in receiving a Processed Data Element from PDH 100. To effect these actions, PDH 100 may publish on a network, the Internet for example, by use of a network presence indexed by an Internet search engine, information related to PDH 100's Processed Data Element offering. By using an Internet search engine, such as Google, DuckDuckGo, or Bing, QR 120 can access PDH 100's network presence and obtain the information. The information may include a description of categories associated with a Perception carried by a Processed Data Element available from PDH 100, along with an network address that can be used by QR 120 to communicate with PDH 100. If QR 120, or any other QR, has an interest in a Processed Data Element provisioned by PDH 100, the QR may establish direct communication with PDH 100 using the provided network address. This initial interaction between QR 120 and PDH 100 is depicted in FIG. 12.

In FIG. 12, PDH 100 first communicates with PDH 100 Network Presence 1200 over Line 1206 and communicates information related to PDH 100's Processed Data Element offering. This information is published on the network by PDH 100 Network Presence 1200, allowing QR 120 to access the information over Line 1202. If after reviewing the information QR 120 has an interest in being provisioned a Processed Data Element from PDH 100, QR 120 may communicate a request to PDH 100's Data Controller, over Line 140, for a Processed Data Element carrying a Perception related to the user of Device 105. This request may be accompanied by a declaration of QR 120's identity, and QR 120's public key, which, in this discussion, may also be referred to as QR 120's public encryption key. If PDH 100's Data Controller determines that the provisioning of a PDH 100 Processed Data Element to QE 120 is of interest, QR 120 may be provisioned a Processed Data Element encrypted to QR 120's public key, carrying a Perception related to the user of Device 105 who, as previously mentioned, is also PDH 100's Data Controller. This provisioning would be effected by use of NCI 300 and a Code Module executing on CPU 310, both of FIG. 3, over Line 140 of FIG. 12, by direct action of PDH 100's Data Controller.

FIG. 12 also illustrates an example constellation of network connected devices that may be used by the data subject who uses Device 105. Each network connected device provides data to PDH 100 related to the use of the particular device by the data subject. Data provided by a network connected device used by the data subject is combined by PDH 100 with data from other network connected devices used by the data subject, and is employed to generate a Processed Data Element carrying a Perception related to the data subject. The processed data may then be provisioned by PDH 100 to QR 120 over Line 140. As depicted in FIG. 12, example devices used by the data subject include: Device 105, a smart phone; Device 1222, a smart car; Device 1224, a tablet computer; Device 1226, a desk top computer; Device 1228, a laptop computer; Device 1230, a smart television; Device 1232, a smart thermostat; and Device 1234, a smart refrigerator. In FIG. 12, Device 105 is shown in communication with QR 120 Network Presence 125 over Line 150, although any smart network connected device used by the data subject may serve in place of Device 105. During communication with QR 120 Network Presence 125 over Line 150, Device 105 may communicate to Network Presence 125 the PDH 100 PDH Identifier communicated to Device 105 from PDH 100 over Line 155 by SDMCM 346 executing on CPU 310 by use of NCI 300. By QR 120 monitoring Network Presence 125 over Line 135, and comparing the PDH 100 PDH Identifier communicated over Line 150 to Network Presence 125 by Device 105 with the PDH Identifier accompanying a PDH 100 Processed Data Element communicated over Line 140 to QR 120 by PDH 100, QR 120 can determine if the data subject who is the subject of the Perception carried by a particular Data Element is most likely in communication with QR 120 Network Presence 125 at any particular time.

Having thus described several aspects of an embodiment of the present invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1) A method of provisioning to a Recipient a Processed Data Element carrying a Perception related to a data subject in compliance with data protection regulations comprising:
acquiring data from a network connected device used by the data subject by use of a network connected apparatus, the device in communication with the apparatus by use of a network communication interface incorporated in the apparatus and a Code Module executing on a Computer Processor Unit incorporated in the apparatus;
storing the acquired data in a data storage unit incorporated in the apparatus by use of a Code Module executing on the Computer Processor Unit incorporated in the apparatus, where the acquired data is disallowed from being provisioned to, or accessed by, the Recipient;
receiving a request from the Recipient, by use of the network communication interface and a Code Module executing on the Computer Processor Unit incorporated in the apparatus, for a Processed Data Element that carries a Perception related to the data subject, the request including a network address to where the Processed Data Element carrying a Perception is to be provisioned by use of the network communication interface;
accessing data acquired from the network connected device used by the data subject stored in the data storage unit by use of the Computer Processor Unit incorporated in the apparatus, and executing one or more Code Modules on the Computer Processor Unit that causes the Computer Processor Unit to process the accessed data and thereby generate the Processed Data Element carrying a Perception related to the data subject, where one or more of such Code Modules are provided by Recipient;
communicating to the device used by the data subject, by use of the network communication interface and a Code Module executing on the Computer Processor Unit incorporated in the apparatus, a presentation of possible implications related to the data subject associated with the provisioning of the Processed Data Element carrying the Perception related to the data subject to the Recipient;
receiving a command from the device used by the data subject, by use of the network communication interface and a Code Module executing on the Computer Processor Unit incorporated in the apparatus, to provision, or to not provision, the Processed Data Element carrying the Perception related to the data subject to the Recipient, such command being received subsequent to the presentation of possible implications related to the data subject associated with the provisioning of the Processed Data Element to the Recipient being communicated to the device used by the data subject;
provisioning to the network address provided by the Recipient the generated Processed Data Element carrying the Perception related to the data subject, by use of a Code Module executing on the Computer Processor Unit incorporated in the apparatus and the network communication interface, when the command received from the device used by the data subject is to provision the Processed Data Element to the Recipient.

2) The method of claim 1 wherein the Processed Data Element carrying the Perception related to the data subject is processed by itself, or in combination with information related to the Recipient, by use of a Code Module executing on the Computer Processor Unit to obtain the presentation of possible implications related to the data subject associated with the provisioning of the Processed Data Element carrying the Perception related to the data subject to the Recipient.

3) The method of claim 1 wherein the Processed Data Element carrying a Perception related to the data subject is marked by a Code Module executing on the Computer Processor Unit with a first apparatus identifier, where said first apparatus identifier may be changed to a second apparatus identifier by command of the data subject for a subsequent Processed Data Element communicated to the Recipient, the second apparatus identifier being unrelated to the first apparatus Identifier.

4) The method of claim 1 wherein at least one of the one or more Code Modules that causes the Computer Processor Unit to process the accessed data and thereby generate a Processed Data Element carrying a Perception related to the data subject is a Code Module that processes the accessed data using artificial intelligence, machine learning, neural network, data mining, or deep learning technology to effect such processing.

5) The method of claim 1 wherein one of the one or more Code Modules that causes the Computer Processor Unit to process the accessed data and thereby generate a Processed Data Element carrying a Perception related to the data subject is a Code Module that separates accessed data stored in the data storage unit acquired from the device used by the data subject into a personal data part and a non-personal data part.

6) The method of claim 5 wherein the data subject directs a Data Element stored in the data storage unit acquired from the device used by the data subject to be treated as being personal or non-personal by the Code Module executed on the Computer Processor Unit that separates accessed data stored in the data storage unit acquired from the device used by the data subject into a personal data part and a non-personal data part.

7) The method of claim 1 wherein the data subject authorizes the execution on the Computer Processor Unit of one or more of the Code Modules that causes the Computer Processor Unit to process the data accessed from the data storage unit and thereby generate a Processed Data Element carrying a Perception related to the data subject from data acquired from the network connected device used by the data subject.

8) The method of claim 1 wherein one of the one or more Code Modules that causes the Computer Processor Unit to process the accessed data and thereby generate a Processed Data Element carrying a Perception related to the data subject, is a parameter controlled Code Module that selects a portion of the data accessed from the data storage unit acquired from the network connected device used by the data subject, where the parameter controls the selectivity of the Code Module.

9) The method of claim 8 wherein the parameter that controls the selectivity of the parameter controlled Code Module executing on the Computer Processor Unit is provided by the data subject or by the recipient.

10) The method of claim 1 wherein the provisioning to the Recipient of the Processed Data Element carrying the Perception related to the data subject is initiated following the detection of an occurrence of an event related to the data subject defined by the Recipient.

11) An apparatus for processing the data of a data subject and provisioning the processed results to a Recipient in compliance with data protection regulations comprising:
an apparatus whose data controller is the data subject, the apparatus comprising:
a Computer Processor Unit;
a Data Storage Unit; and
a Network Communication Interface;
a Code Module executing on the Computer Processor Unit that causes the Computer Processor Unit to acquire data from a network connected device used by the data subject and store the acquired data in the Data Storage Unit, such device being in communication with the apparatus by use of the Network Communication Interface, where subsequent to acquisition the acquired data is disallowed from being provisioned to, or accessed by, the Recipient;
one or more Code Modules executing on the Computer Processor Unit that causes the Computer Processor Unit to process data stored in the Data Storage Unit acquired from the device used by the data subject and thereby generate a Processed Data Element carrying a Perception related to the data subject, where at least one of such Code Modules is downloaded from the Recipient to the apparatus.
a Code Module executing on the Computer Processor Unit that causes the Computer Processor Unit to generate from the Processed Data Element carrying a Perception related to the data subject or information related to the Recipient a presentation of possible implications related to the data subject associated with the provisioning of the Processed Data Element to the Recipient;
a Code Module executing on the Computer Processor Unit that communicates the presentation to the network connected device used by the data subject by use of the Network Communication Interface and a Code Module executing on the Computer Processor Unit;
a Code Module executing on the Computer Processor Unit that causes the Computer Processor Unit to receive from the network connected device used by the data subject, in communication with the apparatus by use of the Network Communication Interface, a command to provision, or to not provision, the Processed Data Element carrying the Perception related to the data subject to the Recipient; and
a Code Module executing on the Computer Processor Unit that causes the Computer Processor Unit to provision to the Recipient, by use of the Network Communication Interface, the Processed Data Element carrying the Perception related to the data subject, when the command received from the device used by the data subject is to provision the Processed Data Element carrying the Perception related to the data subject to the Recipient.

12) The apparatus of claim 11 wherein one of the Code Modules executing on the Computer Processor Unit downloaded from the recipient is a Data Selection Code Module, a Personal Data Separation Code Module, or a Processed Data Element Code Module.

13) The apparatus of claim 11 wherein the one or more Code Modules that cause the Computer Processor Unit to process data stored in the Data Storage Unit acquired from the device used by the data subject and thereby generate the Processed Data Element carrying a Perception related to the data subject, are downloaded to the apparatus from one or more network connected sources.

14) The apparatus of claim 13 wherein at least one of the one or more Code Modules downloaded from one or more network connected sources are authorized for execution on the Computer Processor Unit by the data subject.

15) The apparatus of claim 13 wherein at least one of the Code Modules executing on the Computer Processor Unit downloaded from one or more network connected sources is downloaded to the apparatus from a government agency or from a network connected source approved by a government agency, where such Code Module is a Data Selection Code Module, a Personal Data Separation Code Module, or a Processed Data Element Code Module.

16) The apparatus of claim 11 wherein a Code Module executing on the Computer Processor Unit causes the Computer Processor Unit to communicate a generated User Interface to the network connected device used by the data subject in communication with the apparatus, by use of the Network Communication Interface, the User Interface configured to display the presentation to the data subject on a device information display incorporated in the device and to accept a command from the data subject by use of a device information display incorporated in the device;

17) A system for provisioning to a Recipient a Processed Data Element carrying a Perception related to a data subject in compliance with data protection regulations comprising:
a network connected device used by the data subject;
a network connected data storage and data processing apparatus whose data controller is the data subject; and
the Recipient that receives the Processed Data Element carrying a Perception related to the data subject, wherein:
a Code Module executing on a Computer Processor Unit incorporated in the apparatus acquires data from the network connected device used by the data subject by use of a network communications interface incorporated in the apparatus, stores the acquired data in a data storage unit incorporated in the apparatus, allows access to the acquired stored data by one or more Code Modules executing on the Computer Processor Unit incorporated in the apparatus, and disallows the acquired stored data from being provisioned to, or accessed by, the Recipient;
one or more Code Modules executing on the Computer Processor Unit incorporated in the apparatus causes the Computer Processor Unit to access and process the acquired data stored in the Data Storage Unit, or portions thereof, and thereby generate a Processed Data Element carrying a Perception related to the data subject where at least one of such Code Modules is incorporated in the PDH at the time of PDH manufacture, downloaded to the PDH from the PDH manufacturer or an agent of the PDH manufacturer subsequent to the time of manufacture, downloaded to the PDH from the Recipient or an agent of the Recipient, downloaded to the PDH from a government agency, downloaded to the PDH from a source approved by a government agency, or downloaded to the PDH from an independent Code Module developer;
a Code Module executing on the Computer Processor Unit incorporated in the apparatus generates a presentation from information related to the Recipient or information related to the Perception, and a Code Module executing on the Computer Processor Unit incorporated in the apparatus communicates the presentation to the network connected device used by the data subject by use of the network communications interface incorporated in the apparatus;
an Application Program executing on a Computer Processor Unit incorporated in the network connected device used by the data subject receives the presentation by use of a network communication interface incorporated in the device, and the Application Program presents the presentation to the data subject by use of a two-way information display incorporated in the device;
the data subject communicates to the apparatus controlled by the data subject a command to provision the Processed Data Element carrying the Perception related to the data subject to the recipient immediately, to provision the Processed Data Element carrying the Perception to the recipient following the detection of an occurrence of an event related to the data subject by a Code Module executing on the Computer Processor Unit incorporated in the apparatus, or to not provision the Processed Data Element carrying the Perception to the recipient, by use of the two-way information display incorporated in the device, the Application Program executing on the Computer Processor Unit incorporated in the device, and the network communication interface incorporated in the device;
a Code Module executing on the Computer Processor Unit incorporated in the apparatus causes the Computer Processor Unit to receive the command from the device used by the data subject, by use of the network communication interface incorporated in the apparatus; and
a Code Module executing on the Computer Processor Unit incorporated in the apparatus causes the Computer Processor Unit to provision the Processed Data Element carrying the Perception related to the data subject to the recipient, by use of the network communication interface incorporated in the apparatus, when the command is to provision the Processed Data Element carrying the Perception related to the data subject following the detection of an occurrence of an event related to the data subject by a Code Module executing on the Computer Processor Unit incorporated in the apparatus, or when the command is to provision the Processed Data Element carrying the Perception related to the data subject immediately.

18) The system of claim 17 wherein the Processed Data Element carrying the Perception related to the data subject provisioned to a first Recipient is the result of processing acquired data stored in the Data Storage Unit by a first set of Code Modules executing on the Computer Processor Unit incorporated in the apparatus, while the Processed Data Element carrying the Perception related to the data subject provisioned to a second Recipient is the result of processing acquired data stored in the Data Storage Unit by a second set of Code Modules executing on the Computer Processor Unit incorporated in the apparatus.

19) The system of claim 17 wherein a Code Module executing on the Computer Processor Unit incorporated in the apparatus causes the Computer Processor Unit to mark the Processed Data Element carrying a Perception related to the data subject with Support Data prior to the provisioning of the Processed Data Element carrying the Perception to the Recipient, such Support Data carrying: a time stamp indicating the time the Processed Data Element was generated, the Recipient's identity; the identity of one or more third parties with whom the Recipient may share the Processed Data Element carrying a Perception; the category, or categories, of third parties with whom the Recipient may share the Processed Data Element; the purpose, or purposes, to which the Recipient may apply the Processed Data Element carrying a Perception; the source, or sources, of one or more of the Code Modules used to generate the Processed Data Element carrying the Perception; the event that initiated the provisioning of the Processed Data Element carrying a Perception to the Recipient; or an identifier that identifies the apparatus that provisioned the Processed Data Element carrying a Perception to the Recipient.

20) The system of claim 19 wherein marked Support Data is employed by the Recipient as written evidence that the Recipient has been provided with explicit consent by the data subject to use the Processed Data Element for the benefit of the Recipient.
